(19) United States
(12) Patent Application Publication
(10) Pub. No.: US 2026/0121301 A1
(43) Pub. Date: Apr. 30, 2026

(54) WAVE CONTROL MEDIUM, WAVE CONTROL ELEMENT, WAVE CONTROL MEMBER, AND WAVE CONTROL DEVICE

(71) Applicant: Sony Group Corporation, Tokyo (JP)

(72) Inventor: Eri IGARASHI, Tokyo (JP)

(21) Appl. No.: 18/863,168

(22) PCT Filed: May 26, 2022
(86) PCT No.: PCT/JP2022/021601

§ 371 Date: Jun. 24, 2025

(51) Int. Cl. H01Q 17/00

(52) U.S. Cl. CPC H01Q 17/008

(57) ABSTRACT

To provide a wave control medium capable of absorbing and controlling waves while miniaturizing a metamaterial or the like and also increasing the bandwidth thereof.

The present disclosure provides a wave control medium that includes a three-dimensional microstructure body including a base part, a metamaterial part, and a matching element disposed between the base part and the metamaterial part. The three-dimensional microstructure body is formed of a material selected from any one of a metal, a dielectric, a magnetic body, a conductor, a metal oxide, a semiconductor, and a superconductor, or a combination of a plurality of those above. The metamaterial part may have a helical structure, a multilayer structure, a conical structure, a wire structure, a ring structure, a mushroom structure, or a sphere structure.

### TECHNICAL FIELD

The present disclosure relates to a wave control medium, a wave control element, a wave control member, and a wave control device. More particularly, the present disclosure relates to a wave control medium configured to control waves by an artificial structure body, a wave control element or a wave control member that includes the wave control medium, and a wave control device that includes the wave control element or the wave control member.

### BACKGROUND ART

Metamaterials have a structure with many unit Structure bodies artificially formed, and the properties of substances are controlled by the structure. The structure controls, for example, a permittivity and a magnetic permeability, thus making it possible to control waves such as an electromagnetic wave.

Metamaterials have properties that ordinary materials cannot exhibit, for example, a negative refractive index. On the basis of those properties, it has been proposed to use the metamaterials for reflection, shielding, absorption, or phase modulation of waves such as a radio wave, a light wave, and a sound wave.

The use of metamaterials in small electronic apparatuses has been proposed. In line with this, several proposals for miniaturization of metamaterials have been made so far. For example, the invention described in Patent Literature 1 below has an object to provide a left-handed metamaterial that can be miniaturized. Patent Literature 1 discloses a metamaterial including: a plurality of first resonators (100a: 410:100) each of which generates a negative permittivity with respect to a predetermined wavelength, each of the plurality of first resonators including an internal space; a plurality of second resonators (100b: 420:510, 520) each of which generates a negative magnetic permeability with respect to the predetermined wavelength; and a support member (10) that fixes positions of the first resonators and the second resonators, in which the support member fixes each of the second resonators inside the plurality of first resonators and fixes the plurality of first resonators such that the plurality of first resonators is spatially continuous. Further, Non-Patent Literature 1 below discloses a metamaterial having a structure in which a three-dimensional helical part is disposed on a base part of a two-dimensional square lattice.

### CITATION LIST

### Patent Literature

Patent Literature 1: International Publication No. 2010/026907

### Non-Patent Literature

Non-Patent Literature 1: SCIENCE 18 Sep. 2009: Vol. 325, Issue 5947, pp. 1513-1515, “Gold Helix Photonic Metamaterial as Broadband Circular Polarizer”, Justyna K. Gansel, Michael Thiel, Michael S. Rill, Manuel Decker, Klaus Bade, Volker Saile, Georg Von Freymann, Stefan Linden and Martin Wegener

### DISCLOSURE OF INVENTION

### Technical Problem

A wave control medium, which is the unit structure body of the metamaterial, has a size of approximately 1/10 of a target wavelength, for example. When such unit structure bodies are arranged as an array structure of several units or more, they can exert the function as a metamaterial. For example, in order to control waves with long wavelengths, such as microwaves or sound waves in the range of hearing, the structure of the metamaterial will expand in accordance with the wavelength, which will require a larger footprint. This is particularly problematic when the metamaterial is employed in a small electronic apparatus.

Additionally, the function of the metamaterial is based on the resonance phenomenon caused by the interaction of waves and the structure. Thus, at frequencies other than a resonant frequency, the response intensity thereof may be drastically reduced, that is, the frequency of response may become narrowband. This is particularly problematic when a wide range of frequencies is required to be handled.

In addition, the metamaterial may reflect waves. For example, if electromagnetic waves incident on a metamaterial are reflected, it cannot exert the function of absorbing and controlling waves.

The present disclosure aims to solve at least one of the above-described problems. In particular, the present disclosure aims to provide a wave control medium that can be miniaturized, can respond to a wide range of frequencies, and can suppress reflection of an electromagnetic wave.

### Solution to Problem

The inventors of the present disclosure have found that the use of a matching element is useful in solving the above problems.

Specifically, the present disclosure provides a wave control medium, including
a three-dimensional microstructure body including a base part, a metamaterial part, and a matching element disposed between the base part and the metamaterial part, in which
the three-dimensional microstructure body is formed of a material selected from any one of a metal, a dielectric, a magnetic body, a conductor, a metal oxide, a semiconductor, and a superconductor, or a combination of a plurality of those above.

The metamaterial part may have a helical structure, a multilayer structure, a conical structure, a wire structure, a ring structure, a mushroom structure, or a sphere structure.

The matching element may be formed of a resistive material.

The matching element may be a film or a wire that is formed of a resistive material.

The matching element may be a lumped element.

The metamaterial part may include at least two types of structure bodies, and the at least two types of structure bodies may not be in contact with each other.

The metamaterial part may include at least two types of structure bodies, and the at least two types of structure bodies may not be in contact with each other and may have a continuous structure formed in a manner that the at least two types of structure bodies are entangled with each other.

The metamaterial part may include at least two types of structure bodies, and at least one of the at least two types of structure bodies may have a wire shape, a plate shape, or a sphere shape.

Additionally, the present disclosure also provides a wave control member including the wave control medium.

A specific bandwidth of a response of the wave control member may be 30% or more, and an absorption intensity in the specific bandwidth may be 50% or more.

Additionally, the present disclosure also provides a wave control member for electromagnetic wave absorption or electromagnetic wave shielding, including the wave control medium.

In the wave control member, a plurality of metamaterial parts may be disposed on one matching element.

The one matching element may be a film formed on the base part.

In the wave control member, a plurality of combinations of the matching element and the metamaterial part may be disposed on one base part.

A plurality of matching elements constituting the plurality of combinations may be configured not to be in contact with each other.

Additionally, the present disclosure also provides a wave control element including the wave control medium.

A specific bandwidth of a response of the wave control element may be 30% or more, and an absorption intensity in the specific bandwidth may be 50% or more.

Additionally, the present disclosure also provides a wave control device including a metamaterial including the wave control medium.

Additionally, the present disclosure also provides a wave control device including a sensor including the wave control member.

Additionally, the present disclosure also provides a wave control device that performs transmission/reception or light reception/emission, including the wave control medium.

### BRIEF DESCRIPTION OF DRAWINGS

FIG. 1A is a schematic view of a unit structure body of a metamaterial.

FIG. 1B is a diagram for describing the behavior of the unit structure body of the metamaterial in the case where incident waves are incident.

FIG. 1C is a schematic view of a unit Structure body of a metamaterial.

FIG. 1D is a diagram for describing the behavior of the unit structure body of the metamaterial in the case where incident waves are incident.

FIG. 1E is a schematic view showing an example of a unit structure body of a metamaterial in the form of a perspective view.

FIG. 1F is a schematic view showing an example of a unit structure body of a metamaterial in the form of a perspective view.

FIG. 1G is a schematic view showing a configuration example of a wave control member.

FIG. 1H is a schematic view showing a configuration example of a wave control member.

FIG. 1I is a schematic view showing a configuration example of a wave control member.

FIG. 2 is a perspective view schematically showing configuration examples of a wave control medium including a metamaterial part having a helical structure.

FIG. 3 is a perspective view schematically showing configuration examples of a wave control medium including a metamaterial part having a helical structure.

FIG. 4 is a perspective view schematically showing configuration examples of a wave control medium including a metamaterial part having a helical structure.

FIG. 5 is a perspective view schematically showing a configuration example of a wave control medium including a metamaterial part having a helical structure.

FIG. 6 is a schematic cross-sectional view showing a configuration example of a coaxial cable-type metamaterial part.

FIG. 7 is a schematic view showing a configuration example of a double gyroid metamaterial part.

FIG. 8 is a schematic view showing a configuration example of a metamaterial part having a conical helical structure.

FIG. 9 is a schematic view showing a configuration example of a metamaterial part having a wire structure and a helical structure.

FIG. 10 is a schematic view showing a configuration example of a metamaterial part having a wire structure and a helical structure.

FIG. 11 is a schematic view showing a configuration example of a metamaterial part having a wire structure and a helical structure.

FIG. 12 is a schematic view showing a configuration example of a metamaterial part having a plate structure and a helical structure.

FIG. 13 is a schematic view showing a configuration example of a metamaterial part having a plate structure and a helical structure.

FIG. 14 is a schematic view showing a configuration example of a metamaterial part having a spherical structure and a helical structure.

FIG. 15A is a schematic view showing a configuration example of a wave control medium including a metamaterial part having a mushroom structure.

FIG. 15B is a schematic perspective view showing a state where the wave control media each including a metamaterial part having a mushroom structure are disposed in an array.

FIG. 16A is a schematic view showing a configuration example of a wave control medium including a metamaterial part having a sphere structure.

FIG. 16B is a schematic perspective view showing a state where the wave control media each including a metamaterial part having a sphere structure are disposed in an array.

FIG. 16C is a schematic perspective view showing a state where the wave control media each including a patch-shaped metamaterial part are disposed in an array.

FIG. 17A is a schematic view showing a configuration example of a wave control medium including a laminate-type metamaterial part.

FIG. 17B is a schematic perspective view showing a state where the wave control media each including a laminate-type metamaterial part are disposed in an array.

FIG. 18A is a schematic view showing a configuration example of a wave control medium including a wire-shaped metamaterial part.

FIG. 18B is a schematic perspective view showing a state where the wave control media each including a wire-shaped metamaterial part are disposed in an array.

FIG. 18C is a schematic view showing a configuration example of a wave control medium including a wire-shaped metamaterial part.

FIG. 18D is a schematic perspective view showing a state where the wave control media each including a wire-shaped metamaterial part are disposed in an array.

FIG. 18E is a schematic perspective view showing a state where the wave control media each including a wire-shaped metamaterial part are disposed in an array.

FIG. 19A is a schematic view showing a configuration example of a wave control medium including a ring-shaped metamaterial part.

FIG. 19B is a schematic perspective view showing a state where the wave control media each including a ring-shaped metamaterial part are disposed in an array.

FIG. 19C is a schematic view showing a configuration example of a wave control medium including a ring-shaped metamaterial part.

FIG. 19D is a schematic perspective view showing a state where the wave control media each including a ring-shaped metamaterial part are disposed in an array.

FIG. 20 is a schematic view showing a configuration example of an electromagnetic wave absorbing member according to the present disclosure.

FIG. 21 is a schematic view showing a configuration example of an electromagnetic waveguide according to the present disclosure.

FIG. 22 is a schematic view showing a configuration example of an electromagnetic waveguide according to the present disclosure.

FIG. 23 is a graph for describing a specific bandwidth.

FIG. 24A is a diagram showing the structure of a wave control medium in Reference example used in a simulation of electromagnetic wave absorption characteristics.

FIG. 24B is a diagram showing the structure of a wave control medium in Example used in a simulation of electromagnetic wave absorption characteristics.

FIG. 25 is a diagram for describing a method of simulating electromagnetic wave absorption characteristics.

FIG. 26A is a graph showing simulation results for the wave control medium in Reference example.

FIG. 26B is a graph showing simulation results for the wave control medium in Example.

### MODE(S) FOR CARRYING OUT THE INVENTION

Hereinafter, suitable embodiments of the present disclosure will be described. The embodiments to be described below are examples of representative embodiments of the present disclosure, and the present disclosure is not limited to those embodiments only. Additionally, those embodiments may also be combined with each other.

Note that the description of the present disclosure is given in the following order.
1 First embodiment (wave control medium)
1.1 Summary of present disclosure
(1) Basic concept of present disclosure
(2) Structure and materials
(3) Metamaterial
1.2 Configuration example of wave control medium (helical structure)
(1) Example 1 of wave control medium including single-turn coil type metamaterial part
(2) Example 2 of wave control medium including single-turn coil type metamaterial part
(3) Example 1 of wave control medium including multiple coil type metamaterial part
(4) Example 2 of wave control medium including multiple coil type metamaterial part
(5) Example of manufacturing method for wave control medium
(6) Example of wave control medium including coaxial cable-type metamaterial part
(7) Example of wave control medium including double gyroid-type metamaterial part
(8) Example of wave control medium including metamaterial part having conical helical structure
(9) Example of wave control medium including metamaterial part having wire structure and helical structure
(9-1) Example 1
(9-2) Example 2
(9-3) Example 3
(10) Example of wave control medium including metamaterial part having plate structure and helical structure
(10-1) Example 1
(10-2) Example 2
(11) Example of wave control medium including metamaterial part having spherical structure and helical structure
1.3 Configuration example of wave control medium (mushroom structure)
1.4 Configuration example of wave control medium (sphere structure or patch structure)
1.5 Configuration example of wave control medium (laminate structure)
1.6 Configuration example of wave control medium (wire structure)
1.7 Configuration example of wave control medium (ring structure)
2 Second embodiment (electromagnetic wave absorbing member)
3 Third embodiment (electromagnetic waveguide)
4 Specific bandwidth
5 Use Examples
6 Examples
6.1 Example 1
6.2 Example 2

### 1 First Embodiment (Wave Control Medium)

### 1.1 Summary of Present Disclosure

### (1) Basic Concept of Present Disclosure

First, an outline of a metamaterial including a wave control medium serving as a unit structure body of a medium that controls waves such as an electromagnetic wave and a sound wave is described.

The metamaterial is configured, for example, by aligning unit structure bodies in a dielectric, the unit structure bodies each having a size sufficiently smaller than the wavelength of an electromagnetic wave and having a resonator inside. Note that the interval between the unit structure bodies (resonators) of the metamaterial is set to about 1/10 or less, or about ⅕ or less of the wavelength of the electromagnetic wave to be used.

By setting such a configuration, a permittivity ϵ and/or a magnetic permeability u of the metamaterial can be artificially controlled, and a refractive index n (=±[ϵ μ]^{1/2}) of the metamaterial can be artificially controlled. In particular, in the metamaterial, the refractive index can be set to a negative value with respect to an electromagnetic wave having a desired wavelength by appropriately adjusting, for example, a shape, a dimension, and the like of the unit structure body to simultaneously achieve a negative permittivity and a negative magnetic permeability.

Incidentally, a resonance (operation) frequency ω of the metamaterial is determined by an inductance L and a capacitance C in a case where the metamaterial is described as a circuit according to the LC circuit theory, and the larger the inductance L and the capacitance C, the lower the resonance frequency. In other words, a high-density structure having a large inductance L and a large capacitance C can function for a wave having a long wavelength (=a low frequency) even with a small metamaterial.

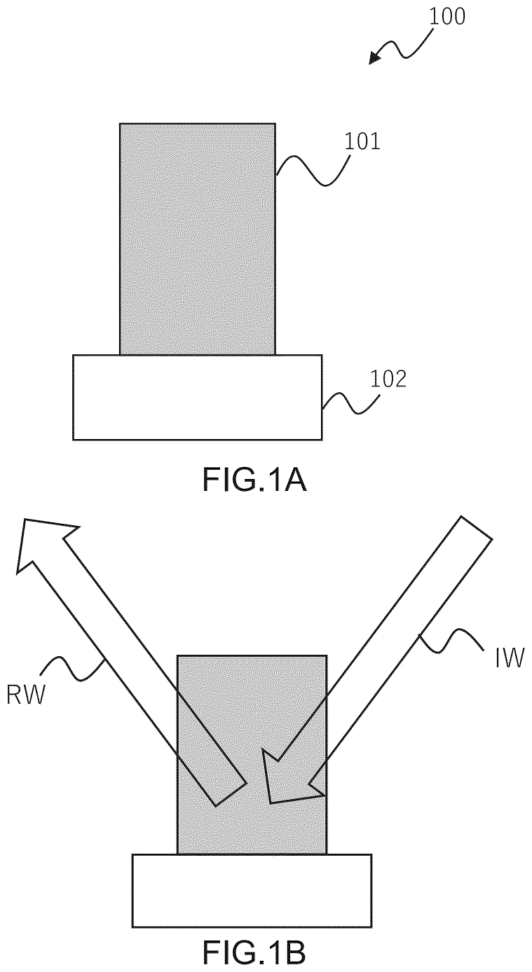

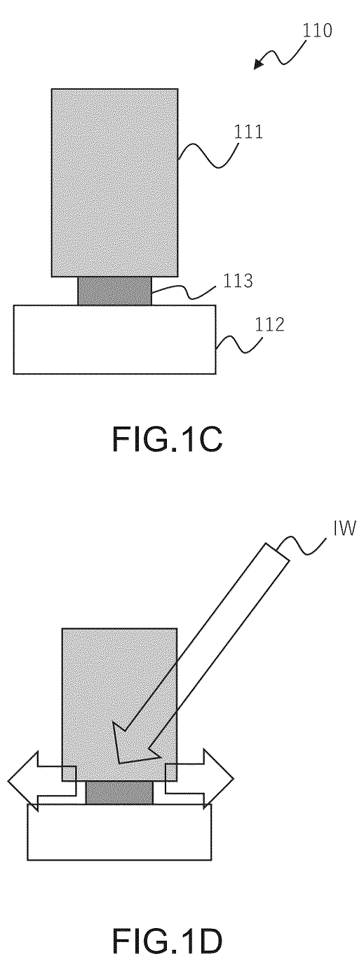

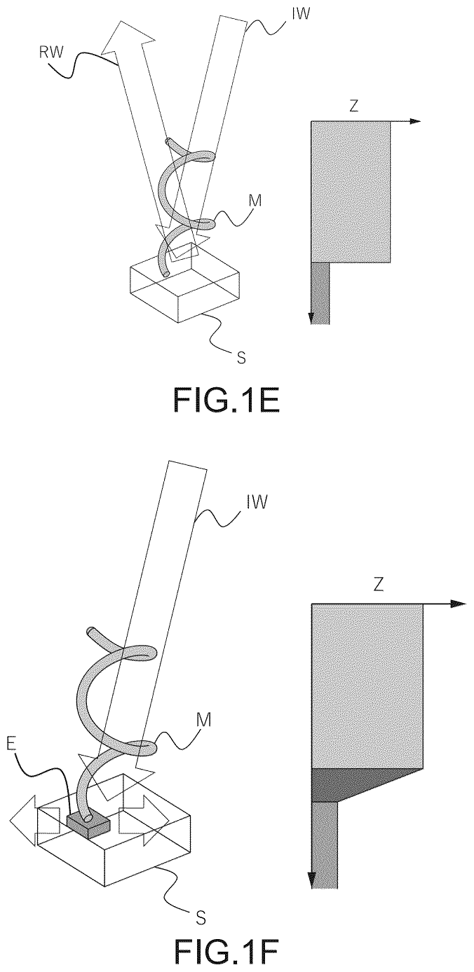

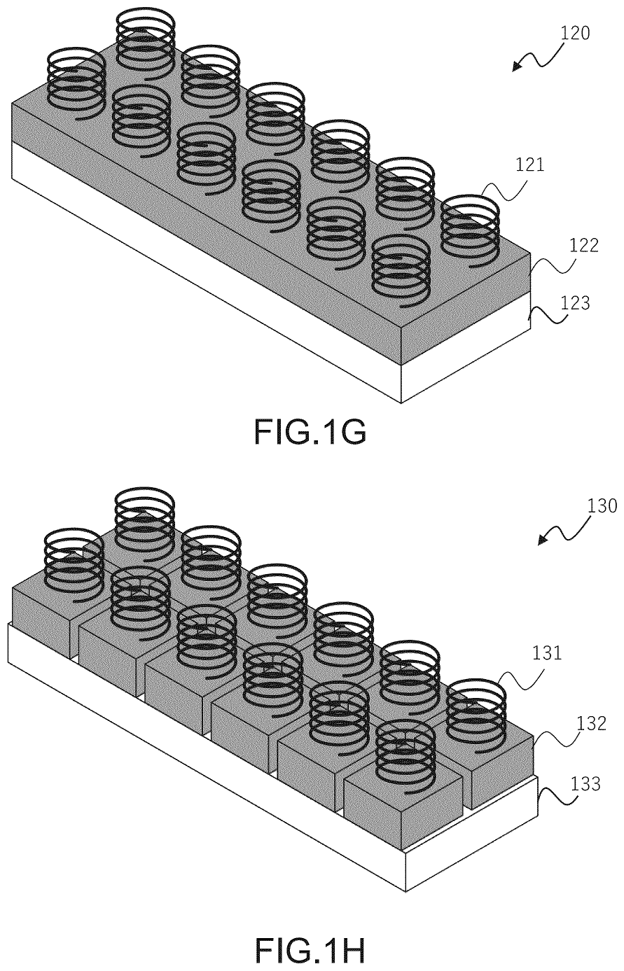

The unit structure body of the metamaterial is configured to include a metamaterial part and a base part to which the metamaterial part is connected. The metamaterial part may be configured, for example, as a resonator. A schematic view of the unit structure body is shown in FIG. 1A. As shown in the figure, a unit structure body 100 includes a base part 102 and a metamaterial part 101 connected to the base part 102.

When an incident wave is incident on such a unit structure body, as shown in FIG. 1B, an incident wave IW may be reflected by the unit structure body. The reflection is considered to be due to the mismatch between an impedance Z1 of the metamaterial part 101 and an impedance Z2 of the base part 102.

FIG. 1C shows a schematic view of a unit structure body of the metamaterial according to the present disclosure. The inventors have found that the above reflection can be prevented by arranging a matching element 113 between a metamaterial part 111 and a base part 112, as shown in the figure. It is also possible to prevent the above reflection over a wide range of frequencies. In other words, the present disclosure provides a wave control medium that includes a three-dimensional microstructure body including a base part, a metamaterial part, and a matching element disposed between the base part and the metamaterial part.

The three-dimensional microstructure body may be formed of, for example, a material selected from any one of a metal, a dielectric, a magnetic body, a conductor, a metal oxide, a semiconductor, and a superconductor, or a combination of a plurality of those above.

In a favorable embodiment, the impedance value of the matching element 113 is between the impedance value of the metamaterial part 111 and the impedance value of the base part 112. To control the impedance values of the three components in such a way, for example, the impedance value of the material of the matching element 113 is the impedance value of the material of the metamaterial part 111 and the impedance value of the material of the base part 112. The matching element with such an impedance value is disposed between the metamaterial part 111 and the base part 112, which facilitates the absorption of the incident wave into the wave control medium and can prevent the reflection described above, as shown in FIG. 1D.

Examples of more specific structures are shown in FIGS. 1E and 1F. In those figures, a metamaterial part having a helical structure is shown as an example of the metamaterial part, and a three-dimensional and schematic view is shown.

As shown in FIG. 1E, a wave control medium including a metamaterial part M and a base part S reflects the incident wave IW due to the difference in impedance Z between those two elements, resulting in generating a reflected wave RW.

On the other hand, as shown in FIG. 1F, a wave control medium including a metamaterial part M, a base part S, and a matching element E disposed between the metamaterial part M and the base part S according to the present disclosure is considered to have a gradual change in impedance Z between the metamaterial part M and the base part S, thereby suppressing the reflection of the incident waves.

### (2) Structure and Material

The metamaterial part may have, for example, a helical structure, a multilayer structure, a conical structure, a wire structure, a ring structure, a mushroom structure, or a sphere structure. Those structures will be described respectively in the following sections. Such structures are suitable for making the wave control medium exhibit its function as a metamaterial (e.g., function as a resonator). The structure of the metamaterial part may be structures other than those listed structures, as long as it can exhibit the function as a metamaterial.

The material of the metamaterial part may include, for example, a material of any one of a metal, a dielectric, a magnetic body, a conductor, a metal oxide, a semiconductor, and a superconductor, or a combination of two or more materials selected from those above. Favorably, the metamaterial part may contain at least a metal, or at least a conductor, or at least a metal oxide.

The metal may be, for example, any one of gold, silver, copper, lead, zinc, tin, iron, and aluminum, or a combination of two or more of them, favorably any one of gold, silver, and copper or a combination of two or three of them. The metal is particularly suitable to exhibit the effects of the present disclosure.

The conductor may be, for example, a non-metallic conductive material, and as a more specific example, a conductive polymer. The conductive polymer may be, for example, polyparaphenylene, polyaniline, polythiophene, or polyparaphenylenevinylene.

The metal oxide may be, for example, a conductive metal oxide and may be, for example, any one of indium tin oxide, zinc oxide, and tin oxide, or a combination of two or three of them.

The metamaterial part may contain, for example, the above-mentioned metal or metal oxide as a component for exhibiting the function as a metamaterial.

In one embodiment, the metamaterial part may contain only the metal or only the metal oxide.

Additionally, the metamaterial part may contain, for example, a metal and a base material, more particularly a base material coated with the metal, particularly a base material plated by the metal. The base material may be, for example, an organic material, particularly a resin, more particularly a light-curing resin.

The material of the matching element may include, for example, a material of any one of a metal, a dielectric, a magnetic body, a conductor, a metal oxide, a semiconductor, and a superconductor, or a combination of two or more materials selected from those above.

The material of the matching element may be a material that smooths the impedance change between the impedance of the metamaterial part and the impedance of the base part when the matching element is disposed between the metamaterial part and the base part.

Favorably, the material of the matching element may be any one of a metal, a dielectric, a magnetic body, a conductor, and a metal oxide, or a combination of two or more of them. Those materials are particularly suitable to exhibit the effects of the present disclosure.

Favorably, the matching element is particularly a resistive material in the materials described above. The resistive material may include, but is not limited to, carbon, a resistive metallic material, a metal glaze, and a metal oxide.

The resistive metallic material may be, for example, but is not limited to, any of a nickel-based metallic material (e.g., nichrome), an iron-based metallic material (e.g., Kanthal), and a manganese-based metallic material (e.g., manganin).

The metal glaze may be, for example, a material containing a metal or metal oxide and glass. The metal glaze may further contain an organic binder.

The metal oxide may be, for example, a tin oxide, an antimony oxide, or a vanadium pentoxide.

In one embodiment, the matching element may be an element in which the material of the matching element described above (especially resistive material) is formed into a film, or an element in which the material of the matching element described above (especially resistive material) is formed into a wire. In a favorable embodiment, the matching element may be a film or wire formed of a resistive material.

For example, the matching element may be one of a carbon film, a resistive metallic material film, a metal glaze film, and a metal oxide film.

Additionally, the matching element may be a wire formed of a resistive metallic material, for example, a nichrome wire, a Kanthal wire, or a manganin wire.

When the matching element is formed into a film, the matching element may form a single film over the surface of the base part, or it may form a film divided into multiple sections. In the former case, a plurality of metamaterial parts may be disposed on a single film. In the latter case, one or more metamaterial parts may be disposed on each of the segmented films.

In other embodiments, the matching element may be a resistor that contains the material of the matching element described above (especially resistive material), such as a winding resistor, a film resistor, a fuse resistor, or a network resistor.

The matching element may be a lumped element. The lumped element means an element whose physical dimensions of circuit elements such as inductance, capacitance, and resistance are sufficiently small with respect to the wavelength of a target wave, and whose wiring length is also sufficiently short. The lumped element may be, for example, a chip resistor including the resistor described above.

The material of the base part may include, for example, a material of any one of a metal, a dielectric, a magnetic body, a conductor, a metal oxide, a semiconductor, and a superconductor, or a combination of two or more materials selected from those above. Favorably, the base part may contain at least a metal or at least a metal oxide.

The metal may be, for example, any one of gold, silver, copper, lead, zinc, tin, iron, and aluminum or a combination of two or more of them, favorably any one of gold, silver, and copper or a combination of two or three of them. The metal is particularly suitable to exhibit the effects of the present disclosure.

The metal oxide may be, for example, a conductive metal oxide and may be, for example, any one of an indium tin oxide, a zinc oxide, and a tin oxide, or a combination of two or three of them.

In a particularly favorable embodiment, the metamaterial part contains a metal or metal oxide (especially favorably a metal, more particularly gold, silver, or copper), the matching element contains a resistive material (e.g., a film, especially a carbon film), and the base part contains a metal or metal oxide (especially favorably a metal, more especially gold, silver, or copper). The wave control medium is formed of such materials, which makes it easier to exhibit the effects of the present disclosure.

### (3) Metamaterial

The present disclosure also provides a metamaterial including a plurality of wave control media according to the present disclosure. The metamaterial is also referred to as a wave control member or wave control element.

The wave control member may mean, for example, a member formed solely from the plurality of wave control media. The member may be, for example, but is not limited to, a film, a sheet, or a coating.

The wave control element may be, for example, an element containing other materials in addition to the plurality of wave control media. The element may be, for example, but is not limited to, an antenna, a lens, or a speaker.

In the metamaterial according to the present disclosure, the wave control media according to the present disclosure may be disposed in an array or may be dispersed, for example. Configuration examples of the wave control member will be described below with reference to FIGS. 1G to 1I. Note that in those figures the metamaterial part has a helical structure, but the metamaterial part included in the wave control member of the present disclosure may be a metamaterial part having other structures described in this specification.

FIG. 1G shows a configuration example of a wave control member (or wave control element) in which the wave control media according to the present disclosure are disposed in an array. A wave control member 120 shown in the figure has a structure in which wave control media including the metamaterial parts each having a helical structure are regularly arranged (in particular, in a lattice-like pattern, more specifically, so as to form multiple rows and multiple columns).

The wave control member 120 includes a base part 123 and one matching element 122 formed to cover the base part 123. A plurality of metamaterial parts 121 is disposed in an array on the surface of the film-like matching element 122.

Thus, in one embodiment of the present disclosure, a plurality of metamaterial parts may be disposed on one matching element. In this embodiment, the one matching element may be a film formed on the base part.

Note that in this figure only the 12 wave control media are shown for convenience of description, but it is needless to say that the number of wave control media included in the wave control member or wave control element according to the present disclosure is not limited to 12. The wave control member or wave control element according to the present disclosure may include many wave control media.

FIG. 1H shows another configuration example of a wave control member (or wave control element) in which the wave control media according to the present disclosure are disposed in an array. A wave control member 130 shown in the figure has a structure in which wave control media including the metamaterial parts each having a helical structure are regularly arranged (in particular, in a lattice-like pattern, more specifically, so as to form multiple rows and multiple columns).

The wave control member 130 includes a base part 133 and a plurality of matching elements 132 formed to cover the base part 133. A metamaterial part 131 is disposed on each of the plurality of matching elements 132. In other words, the plurality of matching elements 132 is separated from each other, and the metamaterial part 131 is provided on each of the separated matching elements 132. The plurality of matching elements 132 may be formed into a film, but may also be in other shapes (e.g., block-like shape).

Further, the plurality of matching elements 132 is rectangular in the figure, but may be circular or oval, or polygonal such as triangular, pentagonal, or hexagonal.

Thus, in one embodiment of the present disclosure, a plurality of combinations of the matching element and the metamaterial part may be disposed on a single base part. In this embodiment, the plurality of matching elements constituting the plurality of combinations may be configured not to be in contact with each other. Additionally, in this embodiment, the matching element may be formed into a film on the base part.

FIG. 1I shows still another configuration example of a wave control member (or wave control element) in which the wave control media according to the present disclosure are disposed in an array. A wave control member 140 shown in the figure has a structure in which wave control media including the metamaterial parts each having a helical structure are regularly arranged (in particular, in lattice-like pattern, more specifically, so as to form multiple rows and multiple columns).

The wave control member 140 includes a base part 143. A plurality of wire-like matching elements 142 is disposed on the base part. Further, a metamaterial part 141 having a helical structure is coupled to each of the wire-like matching elements 142. In other words, in this configuration example, the plurality of wire-like matching elements 142 is separated from each other, and each of the separated matching elements 142 is provided with the metamaterial part 141. One end of one wire-like matching element 142 may be coupled to the metamaterial part 141 and the other end thereof may be coupled to the base part 143.

Thus, in one embodiment of the present disclosure, a plurality of combinations of the matching element and the metamaterial part may be disposed on a single base part. In this embodiment, the plurality of matching elements constituting the plurality of combinations may be configured not to be in contact with each other. Additionally, in this embodiment, the matching element may have a wire-like shape.

Additionally, according to the wave control medium of the present disclosure, the wave control element (antenna, lens, speaker, or the like) using the wave control medium can be significantly downsized. In addition, according to the wave control medium, new functions such as complete shielding, absorption, rectification, and filtering that cannot be achieved by a natural material can be performed. Moreover, the wave control medium can exhibit the above effect not only in an electromagnetic wave but also in a wide range such as a light wave and a sound wave. In particular, a wave control medium 1 can exert an effect in a region having a long wavelength and a wide bandwidth.

In other words, the present disclosure provides a wave control element including a wave control medium according to the present disclosure. The wave control element may include the wave control medium in at least a portion of the element. The wave control element may include, for example, a metamaterial including the wave control medium.

Additionally, the present disclosure can provide a wave control member including the wave control medium. For example, an antireflection film, an antireflection paint, a filter, an energy conversion member, or a photoelectric conversion member can be applied as the wave control member. In one embodiment, the wave control member may be a wave control member for electromagnetic wave absorption or electromagnetic wave shielding.

In other words, the present disclosure provides a wave control member including a wave control medium according to the present disclosure. The wave control member may include the wave control medium, e.g., a metamaterial including the wave control medium.

Additionally, the wave control medium of the present disclosure can also provide a wave control device including a metamaterial including the wave control medium. The wave control device may include components such that wave control is performed by the wave control member or wave control element according to the present disclosure. The wave control device may be, for example, but is not limited to, an antenna, a sensor (e.g., an infrared sensor or a visible light sensor), or an electromagnetic wave measurement device. They can be applied.

In other words, the present disclosure provides a wave control device including a wave control medium according to the present disclosure. The wave control device may include the wave control medium as the wave control element or wave control member described above.

In one embodiment, the wave control device of the present disclosure may include a sensor including the wave control member described above. Additionally, in one embodiment, the wave control device of the present disclosure may be configured as a device that performs transmission/reception or light reception/emission. In other words, the device may include a transmitter and/or a receiver. Additionally, the device may include a light receiver and/or a light emitter.

In the following, more specific examples of the wave control medium according to the present disclosure will be described.

### 1.2 Configuration Examples of Wave Control Medium (Helical Structure)

### (1) Example 1 of Wave Control Medium Including Single-Turn Coil Type Metamaterial Part

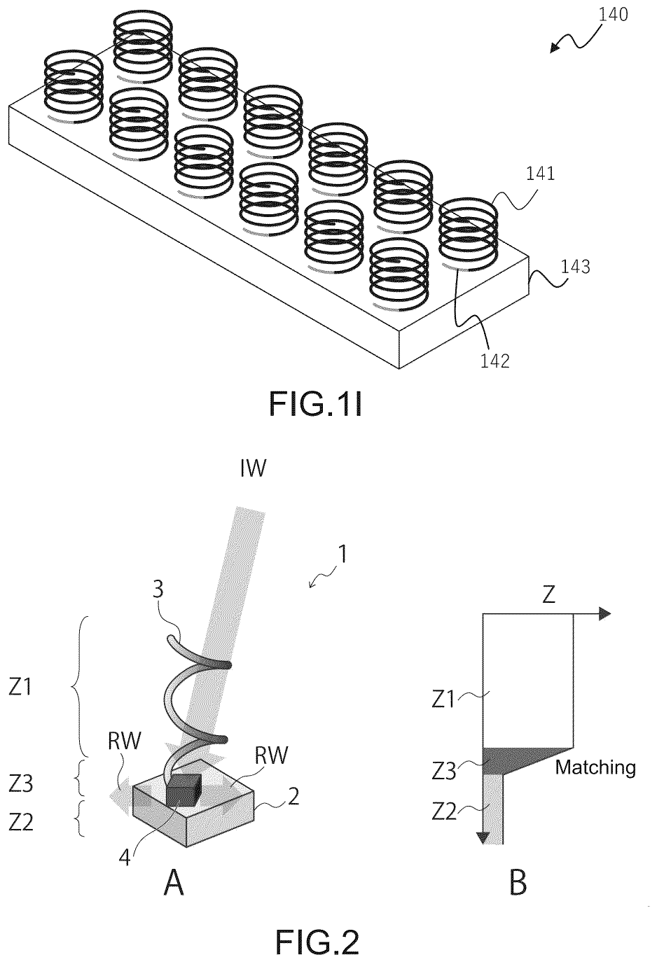

In a favorable embodiment, the metamaterial part may have a helical structure. The metamaterial part having a helical structure is particularly suitable for miniaturization of a metamaterial. Additionally, the metamaterial part having a helical structure is also suitable to make a metamaterial responsive over a wide bandwidth. This embodiment will be described below with reference to FIG. 2. A of FIG. 2 is a perspective view showing a configuration example of a single-turn coil type wave control medium 1. B of FIG. 2 is a diagram for describing impedance matching of the wave control medium 1. The wave control medium 1 is a unit structure body of a metamaterial and can control waves such as an electromagnetic wave and a sound wave, for example.

As shown in A of FIG. 2, the wave control medium 1 includes, as an example, a three-dimensional microstructure body including a base part 2 formed in a substrate or a rectangular parallelepiped, a metamaterial part 3 formed to have a helical structure, and a matching element 4 disposed between the base part 2 and the metamaterial part 3. Such a three-dimensional microstructure body may be formed of a material selected from any one of a metal, a dielectric, a magnetic body, a semiconductor, and a superconductor, or a combination of a plurality of those above.

As an example, a loss type element including a resistor, a circuit type element including a capacitor and an inductor, or the like can be applied as the matching element 4. In the figure, the matching element 4 has a shape having a size smaller than the base part 2 and is formed on the base part 2.

The matching element 4 may be large enough to be coupled to one end of the metamaterial part 3. In the figure, the matching element 4 has a rectangular parallelepiped shape, but it may have other shapes.

The metamaterial part 3 may have a helical structure, and more particularly, include a wire-like material formed to draw a helical curve. The fact that the metamaterial part 3 includes a single-turn coil having such a three-dimensional helical structure as a unit microstructure body of the metamaterial contributes to enabling both miniaturization and increase in bandwidth of the metamaterial.

The metamaterial part 3 is in contact with the matching element 4. The metamaterial part 3 may not be in contact with the base part 2 or may be in contact with the base part 2. The matching element 4 may be in contact with the base part 2.

A metamaterial having a three-dimensional coil structure resonates with a wave having a wavelength equal to that of the coil length of the metamaterial and a shorter wave having a wavelength being one over constant part thereof, and exhibits characteristics of responding to the frequencies in a wide range in which a plurality of resonance peaks is broad-coupled. The wave control medium 1 enables miniaturization by forming a fine structure and can achieve a metamaterial having the characteristics of responding to the frequencies in a wide range by the metamaterial part 3 having a helical structure (especially a three-dimensional coil structure).

An impedance value Z1 of the metamaterial part 3 and an impedance value Z2 of the base part 2 are often greatly different from each other due to a difference in materials. Therefore, when the base part 2 and the metamaterial part 3 are directly joined to each other, due to impedance mismatch between the base part 2 and the metamaterial part 3, an incident wave IW such as an electromagnetic wave is reflected at a joined portion between the base part 2 and the metamaterial part 3, and the wave cannot be absorbed. In other words, energy cannot be dissipated in the base part 2.

As shown in A and B of the same figure, the wave control medium 1 includes the matching element 4 disposed between the base part 2 and the metamaterial 3. The matching element 4 has an impedance value Z3 for filling a difference between the impedance values of the base part 2 and the metamaterial part 3. The matching element 4 having the impedance value Z3 is disposed to make the entire impedance value of the wave control medium 1 change gently and to suppress the reflection of the incident wave IW, which enables absorption in the base part 2.

As described above, the wave control medium 1 can achieve miniaturization of the metamaterial, a component, or an element that includes the wave control medium 1, and increase the bandwidth of response frequencies, and can also absorb and control waves. Further, according to the wave control medium 1, it is also possible to provide a three-dimensional metamaterial exhibiting an electromagnetic wave absorbing function with high efficiency over a wide range of frequencies.

### (2) Example 2 of Wave Control Medium Including Single-Turn Coil Type Metamaterial Part

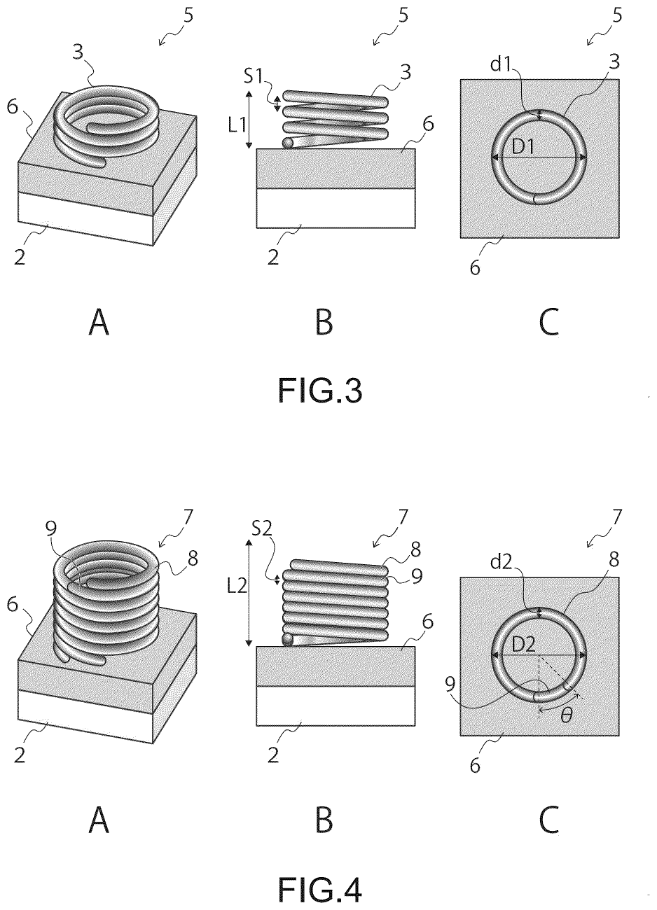

Next, another example of a wave control medium according to the present disclosure will be described with reference to FIG. 3. A of FIG. 3 shows a configuration example of a wave control medium 5 according to the present disclosure in the form of a perspective view. B of FIG. 3 shows a side view showing the configuration example of the wave control medium 5. C of FIG. 3 shows a plan view showing the configuration example of the wave control medium 5. The wave control medium 5 may be a unit structure body of the metamaterial as described in (1) above.

As shown in A of FIG. 3, the wave control medium 5 includes a three-dimensional microstructure body including a base part 2, a metamaterial part 3, and a matching element 6. The base part 2 may have a substrate-like or rectangular parallelepiped shape as shown in the figure. The metamaterial part 3 has a helical structure. The matching element 6 is disposed between the base part 2 and the metamaterial part 3. Unlike the wave control medium 1 described in (1) above, the matching element 6 is disposed over the entire surface of the base part 2. Thus, the matching element 6 may be formed, for example, into a film or a layer.

The base part 2 of the wave control medium 5 may be formed, for example, of a resin or a dielectric. The helical part 3 of the wave control medium 5 may be formed, for example, of a thin copper wire. The matching element 6 may be formed, for example, of a copper plate, a resin, or a resistance element.

As shown in B of the same figure, a height L1 of the metamaterial part 3 may be, for example, 1/1000 to 1/1 of the wavelength of the incident wave, favorably 1/100 to ½ of the wavelength of the incident wave. The numerical range of the height L1 also applies to the height of the metamaterial part having other structures to be described below (other helical structures and structures of metamaterial parts to be described in 1.3 to 1.7, respectively).

A width S1 between the turns of the helix of the metamaterial part 3 in the direction perpendicular to the surface of the base part 2 may be, for example, 1/2000 to ¼ of the wavelength of the incident wave and is favorably 1/1000 to 1/10 of the wavelength of the incident wave. The wave control medium 5 has a structure that exerts a role equivalent to that of a capacitor by the interval of the width S1.

As shown in C of the same figure, a diameter D1 of one turn of the helix of the metamaterial part 3 is, for example, 1/500 to ⅔ of the wavelength of the incident wave, favorably 1/100 to ½ of the wavelength of the incident wave. The numerical range of the diameter D1 may be applied as the numerical range of the maximum dimension in the width direction (maximum dimension in the direction horizontal to the surface of the base part) of the metamaterial part having other structures to be described below (other helical structures and structures of metamaterial parts to be described in 1.3 to 1.7, respectively).

Additionally, a width d1 of the thin copper wire of the helix of the metamaterial part 3 is, for example, 1/2000 to 1/50 of the wavelength of the incident wave, favorably 1/1000 to 1/100 of the wavelength of the incident wave.

According to the wave control medium 5, the above configuration makes it possible to absorb and control waves while achieving miniaturization of a metamaterial that includes the wave control medium 1 or the like and increasing the bandwidth, similarly to the first embodiment.

### (3) Example 1 of Wave Control Medium Including Multiple Coil Type Metamaterial Part

A configuration example of a wave control medium according to the present technology will be described with reference to FIG. 4. A of FIG. 4 shows a configuration example of a wave control medium 7 including a multiple coil type metamaterial part according to the present disclosure in the form of a perspective view. B of FIG. 4 is a side view showing the configuration example of the wave control medium 7, and C of FIG. 4 is a plan view showing the configuration example of the wave control medium 7. The wave control medium 7 is a unit structure body of the metamaterial similarly to the first embodiment.

As shown in A of FIG. 4, the wave control medium 7 includes a three-dimensional microstructure body including a base part 2, a metamaterial part (helices 8 and 9), and a matching element 6. The base part 2 may have a substrate-like or rectangular parallelepiped shape as shown in the figure. The helices 8 and 9 of the metamaterial part form a double helical structure such that the helices 8 and 9 overlap perpendicularly to the surface of the base part 2. The helices 8 and 9 are configured to form a single cylindrical shape. The matching element 6 is stacked on the base part 2. The metamaterial part (helices 8 and 9) is disposed on the matching element 6.

As shown in B of FIG. 4, a height L2 of the metamaterial part (helices 8 and 9) may be, for example, 1/1000 to ⅔ of the wavelength of the incident wave, favorably 1/100 to ½ of the wavelength of the incident wave.

A width S2 between the helices 8 and 9 (a width in the direction perpendicular to the surface of the base part 2) may be, for example, 1/2000 to ⅕ of the wavelength of the incident wave, favorably 1/1000 to 1/10 of the wavelength of the incident wave. The wave control medium 7 has a structure in which each of the helices 8 and 9 has a role equivalent to that of reactance, and has a role equivalent to that of a capacitor by the interval of the width S2.

Additionally, as shown in C of FIG. 4, a diameter D2 of one turn of the helices 8 and 9 is, for example, 1/500 to ⅔ of the wavelength of the incident wave, favorably 1/100 to ½ of the wavelength of the incident wave.

Moreover, a width d2 of the thin copper wire of the helices 8 and 9 is, for example, 1/2000 to 1/50 of the wavelength of the incident wave, favorably 1/1000 to 1/100 of the wavelength of the incident wave. A deviation in the helical direction (circumferential direction) between an end of the helix 8 and an end of the helix 9 is favorably 1° to 90° when expressed by a center angle θ of one turn.

The materials of the helix 8 and the helix 9 may be the same or may be different. Additionally, the helix 8 and the helix 9 form a capacitor between the lower surface of the helix 8 and the upper surface of the helix 9 facing each other, and form an inductor by forming a three-dimensional multiple resonance structure by the helical structure of the helix 8 and the helix 9.

The wave control medium 7 multiplexes the three-dimensional coil structure to increase inductance, and meanwhile, increases capacitance by acting as a capacitor between the thin wires.

Therefore, according to the wave control medium 7, it is possible to achieve a metamaterial that is miniaturized by the fine structure and has more broadband characteristics by the three-dimensional multiple resonance structure. In addition, the wave control medium 7 can absorb and control the wave by including the matching element 6, as described in (1) and (2) above.

As described above, in one embodiment of the present disclosure, the metamaterial part may include at least two types of structure bodies, and the at least two types of structure bodies are not in contact with each other. Other examples including two types of structure bodies will further be described below.

### (4) Example 2 of Wave Control Medium Including Multiple Coil Type Metamaterial Part

Next, a configuration example of a metamaterial part included in a wave control medium according to the present disclosure will be described with reference to FIG. 5. FIG. 5 shows a configuration example of a multiple coil type metamaterial part 10 included in the wave control medium according to the present disclosure in the form of a perspective view. The metamaterial part 10 is a unit structure body of the metamaterial and can control waves such as an electromagnetic wave and a sound wave. The metamaterial part 10 may be disposed on a matching element in the same manner as the metamaterial part of the wave control medium 7 described in (3) above.

The metamaterial part 10 shown in the figure includes a coil 11 and a coil 12 that constitute a three-dimensional microstructure body having a helical structure. The metamaterial part 10 forms a double helical structure of thin wires in which the coils 12 and 13 are wound in parallel to each other while the coil 12 faces the outer side of the coil 11. The metamaterial part 10 is not limited to a double coil, and may have a multiple coil structure of a triple or more coil. In the case of multiple coils such as a triple or more coil, the facing directions of the coils are not limited to be in the parallel positional relationship, and it is sufficient that the coils are arranged so as not to be in direct contact with each other.

Each of the coil 11 and the coil 12 is formed in a thin wire formed of a material selected from any one of a metal, a dielectric, a magnetic body, a semiconductor, and a superconductor, or a combination of a plurality of those above. The materials of the coil 11 and the coil 12 are not necessarily the same, and may be different materials. Additionally, the coil 11 and the coil 12 form a capacitor between the side surface of the coil 11 and the side surface of the coil 12, the coil 11 and the coil 12 facing each other, and form an inductor by forming a three-dimensional multiple resonance structure by the coil 11 and the coil 12 having the helical structure.

The wave control medium according to the present disclosure including the metamaterial part 10 provides a solution for simultaneously achieving miniaturization and increase in bandwidth using a three-dimensional multiple coil including the plurality of thin conductor wires facing each other, as the unit microstructure body of the metamaterial.

A metamaterial having a three-dimensional coil structure is known to resonate with a wave having a wavelength equal to that of the coil length of the metamaterial and a shorter wave having a wavelength being one over constant part thereof, and to exhibit broadband characteristics in which a plurality of resonance peaks is broad-coupled. Further, the relationship between the size and the wavelength of a metamaterial structure depends on inductance and capacitance when the metamaterial structure is regarded as an equivalent circuit, and a metamaterial having a larger inductance and a larger capacitance can be made smaller.

The wave control medium of the present disclosure including the metamaterial part 10 multiplexes the three-dimensional coil structure to increase inductance, and meanwhile, increases capacitance by acting as a capacitor between the thin wires. Therefore, according to the wave control medium, it is possible to achieve a metamaterial that is miniaturized by the fine structure and has broadband characteristics by the three-dimensional multiple resonance structure.

Additionally, according to the wave control medium, the wave control element (antenna, lens, speaker, or the like) using the wave control medium can be significantly downsized. In addition, according to the wave control medium, new functions such as complete shielding, absorption, rectification, and filtering that cannot be achieved by a natural material can be performed. Moreover, the wave control medium can exhibit the above effect not only in an electromagnetic wave but also in a wide range such as a light wave or a sound wave. In particular, the wave control medium 10 can exert an effect in a region having a long wavelength and a wide bandwidth.

### (5) Example of Manufacturing Method for Wave Control Medium

The wave control medium according to the present disclosure may be manufactured, for example, by a molecular template method. Here, the molecular template method refers to a method in which a microscopic and complicated structure body obtained from an organic substance (such as artificial polymer, biopolymer, nanoparticle, and liquid crystal molecule) is used as a template to form a microstructure body formed of a material selected from any one of a metal, a dielectric, a magnetic body, a semiconductor, and a superconductor, or a combination of a plurality of those above. As the molecular template method, two methods described later are mainly known.

In other words, the present disclosure also provides a method of manufacturing a wave control medium, in which a microstructure body formed of a material selected from any one of a metal, a dielectric, a magnetic body, a semiconductor, and a superconductor, or a combination of a plurality of those above is formed to have a three-dimensional structure by molecular template using self-organization of organic materials. The microstructure body may be a three-dimensional microstructure body included in a wave control medium according to the present disclosure.

The first method is a method of coating an organic structure body with plating or the like. The second method is a method of forming a structure body by using an organic substance into which a precursor such as a metal or an oxide is previously introduced, and then converting the precursor into a metal, an oxide, or the like after the structure body is fired, oxidized and reduced, and like.

In the method of manufacturing the wave control medium of the present disclosure, a metallic helical structure of the metamaterial part may be formed by plating, such as by a plating method, on a template of a three-dimensional helical structure formed of an organic material.

For example, the self-organization of an organic material can be used to form the template, which can form a three-dimensional fine structure of the metamaterial part.

Additionally, the template may be, for example, a cured product of light-curing resin. Irradiating the light-curing resin with laser light makes it possible to form a desired three-dimensional structure. For example, the laser light can be scanned three-dimensionally to form a desired three-dimensional structure.

The plating may be an electrolytic or electroless plating method. By using such plating methods, the template can be coated with a metallic material in the form of a thin film. As described above, a template of a desired shape can be manufactured as needed by scanning of the laser light, and a metamaterial part of a desired shape can be manufactured by performing plating on the manufactured template in such a manner.

The base part and the matching element may be manufactured by a person skilled in the art according to those materials and shapes.

The base part may be, for example, a metal substrate, a glass epoxy substrate, a polyimide film, a copper-clad epoxy substrate, a paper phenolic substrate, a paper epoxy substrate, a ceramic substrate, a fluorine-based substrate, silicon, or glass.

Additionally, a film-like matching element may be formed on the base part. The film-like matching element may be formed by depositing a film of the material forming the matching element (e.g., resistor paste, especially carbon paste, etc.) by a deposition method such as screen printing, spin coating, or bar coating. Alternatively, the film of the material forming the matching element may be formed by vapor deposition or sputtering.

In addition, a matching element configured as a wire or element may be formed on the base part. In this case, the metamaterial part may be soldered to the wire or element and the wire or element may be soldered to the base part.

As described above, a wave control medium according to the present disclosure may be manufactured.

Note that the wave control medium 10 may be manufactured by a method of forming a three-dimensional helical structure using the fact that a metal pattern is deflected due to stress after etching of a metal film manufactured on a substrate such as a dielectric.

### (6) Example of Wave Control Medium Including Coaxial Cable-Type Metamaterial Part

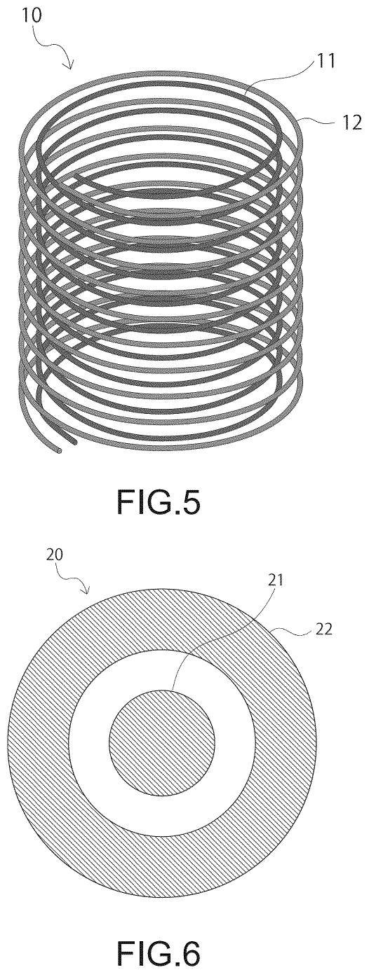

A configuration example of a wave control medium of the present disclosure including a coaxial cable-type metamaterial part will be described with reference to FIG. 6. FIG. 6 shows a cross-sectional view of a coaxial cable-type metamaterial part 20 as the configuration example. The metamaterial part 20 forms part of a unit structure body of the metamaterial as described in (1) to (4) above. The metamaterial part 20 is in contact with a matching element and the matching element is in contact with a base part, as described in (1) to (4) above. The wave control medium of the present disclosure may include a three-dimensional microstructure body including the metamaterial part 20, the matching element, and the base part.

For example, each helix of the metamaterial part of the wave control medium described in (1) to (4) above may have a coaxial cable-type structure as shown in the same figure. Additionally, each helix of a metamaterial part of a wave control medium to be described in (8) below and thereafter may have a coaxial cable-type structure as shown in the same figure. In other words, the metamaterial part included in the wave control medium of the present disclosure may have a helical structure formed of a wire-like material having a coaxial cable-type cross-section.

The metamaterial part 20 is a wire-like material with a coaxial cable-type cross-sectional structure as shown in the figure. The wire-like material may form a helix of the metamaterial part. The cross-section of the metamaterial part 20 has a layered structure in the form in which, for example, an outer surface of a coil 21, which constitutes a three-dimensional microstructure body formed in a helical structure similarly to the wave control medium 10 described above, is covered with the inner surface of a coil 22 with a minute void region or resin region interposed therebetween. The metamaterial part 20 forms a single coil structure as a whole, but includes two three-dimensional microstructure bodies formed by the coil 22 and the coil 21 incorporated in the coil 22.

Note that the metamaterial part 20 has a two-layer structure of the coil layer 21 and the coil layer 22 as described above, but the metamaterial part 20 may include three or more layers. In the case of including three coil layers in such a manner, a void region or a resin region may be provided between the layers, as in the metamaterial part 20 described above.

The coil 21 and the coil 22 are each formed in a thin wire. The coil 21 and the coil 22 form a capacitor between the outer side surface of the coil 21 and the inner side surface of the coil 22, the coil 21 and the coil 22 facing each other, and form an inductor by forming a three-dimensional multiple resonance structure by the coil 21 and the coil 22 having the helical structure.

The wave control medium according to the present disclosure including the metamaterial part 20 multilayers the three-dimensional coil structure to increase inductance, and meanwhile, increases capacitance by acting as a capacitor in a space between the outer side surface of the coil 21 and the inner side surface of the coil 22, both of which are the thin wires. Therefore, according to the wave control medium, as in the examples described in (1) to (4) above, it is possible to achieve a metamaterial that is miniaturized by the fine structure and has broadband characteristics by the three-dimensional multiple resonance structure.

### (7) Example of Wave Control Medium Including Double Gyroid-Type Metamaterial Part

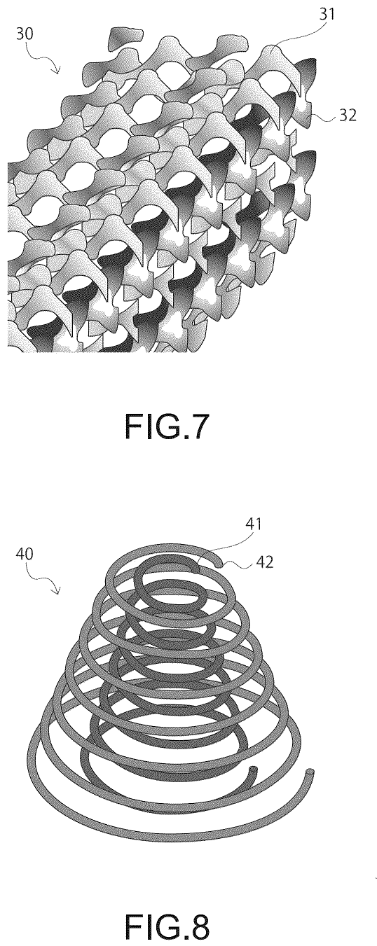

A wave control medium of the present disclosure including a double gyroid-type metamaterial part will be described with reference to FIG. 7. FIG. 7 shows a configuration example of a double gyroid-type metamaterial part 30 in the form of a perspective view. The metamaterial part 30 also forms a unit structure body of the metamaterial as described in (1) to (4) above. The metamaterial part 30 also forms part of a unit structure body of the metamaterial as described in (1) to (4) above. The metamaterial part 30 is in contact with a matching element and the matching element is in contact with a base part, as described in (1) to (4) above. The wave control medium of the present disclosure may include a three-dimensional microstructure body including the metamaterial part 30, the matching element, and the base part.

As shown in the figure, the metamaterial part 30 has a double gyroid-type structure. Here, the double gyroid refers to a continuous structure in which two coils face each other and are entangled without being in contact with each other. The metamaterial part 30 includes a coil 31 and a coil 32 of a three-dimensional microstructure body, and forms a continuous three-dimensional structure in which the coil 31 and the coil 32 face each other and are entangled without being in contact with each other. Note that the metamaterial part 30 is not limited to a double gyroid including a double coil, and may be a gyroid having a multiple coil structure of a triple or more coil.

The coil 31 and the coil 32 may be each formed in a thin wire. The coil 31 and the coil 32 form a capacitor between the side surface of the coil 31 and the side surface of the coil 22, the coils facing each other, and form an inductor by forming a three-dimensional multiple resonance structure by the coil 31 and the coil 32 having the continuous three-dimensional structure.

The metamaterial part 30 multiplexes the three-dimensional coil structure to increase inductance, and meanwhile, increases capacitance by acting as a capacitor in a space between the side surface of the coil 31 and the side surface of the coil 22. Therefore, according to the metamaterial part 30, as in the examples described in (1) to (4) above, it is possible to achieve a metamaterial that is miniaturized by the fine structure and has broadband characteristics by the three-dimensional multiple resonance structure.

As described above, in one embodiment of the present disclosure, the metamaterial part may include at least two types of structure bodies, and the at least two types of structure bodies are not in contact with each other and have a continuous structure formed in a manner that the at least two types of structure bodies are entangled with each other.

### (8) Example of Wave Control Medium Including Metamaterial Part Having Conical Helical Structure

An example of a wave control medium including a metamaterial part having a conical helical structure will be described with reference to FIG. 8. FIG. 8 shows a configuration example of a metamaterial part 40 having a conical helical structure in the form of a perspective view. The metamaterial part 40 also forms part of a unit structure body of the metamaterial as described in (1) to (4) above. The metamaterial part 40 is in contact with a matching element and the matching element is in contact with a base part, as described in (1) to (4) above. The wave control medium of the present disclosure may include a three-dimensional microstructure body including the metamaterial part 40, the matching element, and the base part.

As shown in the figure, the metamaterial part 40 has, as a whole, a conical shape with the diameter of the helix gradually increasing toward the lower side of the figure. The metamaterial part 40 includes a coil 41 and a coil 42 that constitute a three-dimensional microstructure body, and forms a double helical structure of thin wires in which the coils 41 and 42 are wound in parallel to each other while the coil 42 faces the outer side of the coil 41. Note that the metamaterial part 40 is not limited to a double coil, and may have a multiple coil structure of a triple or more coil. Additionally, the metamaterial part 40 may have, as a whole, a conical shape with the diameter of the helix gradually decreasing toward the lower side of the figure.

The coil 41 and the coil 42 may be each formed in a thin wire. The coil 41 and the coil 42 form a capacitor between the side surface of the coil 41 and the side surface of the coil 42, the coils facing each other, and form an inductor by forming a three-dimensional multiple resonance structure by the coil 41 and the coil 42 having the conical helical structure.

The metamaterial part 40 multiplexes the three-dimensional coil structure to increase inductance, and meanwhile, increases capacitance by acting as a capacitor in a space between the side surface of the coil 41 and the side surface of the coil 42. Therefore, according to the metamaterial part 40, as in the examples described in (1) to (4) above, it is possible to achieve a metamaterial that is miniaturized by the fine structure and has broadband characteristics by the three-dimensional multiple resonance structure.

(9) Example of Wave Control Medium Including Metamaterial Part Having Wire Structure and Helical Structure

A metamaterial part of a wave control medium of the present disclosure may have a combination of two or more types of structures. Combining two or more types of structures makes it possible to, for example, cause each structure to function with respect to an electric field and a magnetic field constituting an electromagnetic wave, that is, to share functions between the structures.

In other words, in one embodiment, the metamaterial part may include at least two types of structure bodies, and the at least two types of structure bodies do not need to be in contact with each other. Additionally, the metamaterial part may include at least two types of structure bodies, and at least one of the at least two types of structure bodies may have a wire shape.

Here, functioning with respect to the electric field will control a relative permittivity ϵr, and functioning with respect to the magnetic field will control the relative magnetic permeability μr. Therefore, the wave control medium according to the present disclosure includes a metamaterial part including a combination of multiple types of structure bodies, so that the relative permittivity and the relative magnetic permeability can be controlled to desired values with a high degree of freedom.

### (9-1) EXAMPLE 1

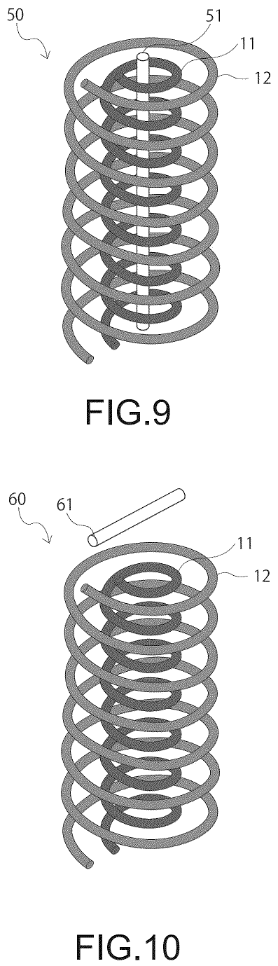

Referring to FIG. 9, an example of a metamaterial part having a wire structure and a helical structure will be described. FIG. 9 shows a configuration example of a metamaterial part 50 having a wire structure and a helical structure in the form of a perspective view. The metamaterial part 50 may have the same configuration as the metamaterial part 10, except that the wire structure is combined with the double coil structure. In other words, the description for the metamaterial part 10 applies to the metamaterial part 50 as well.

The metamaterial part 50 also forms part of the unit structure body of the metamaterial as described in (1) to (4) above. The metamaterial part 50 is in contact with a matching element and the matching element is in contact with a base part, as described in (1) to (4) above. The wave control medium of the present disclosure may include a three-dimensional microstructure body including the metamaterial part 50, the matching element, and the base part.

As shown in the figure, the metamaterial part 50 includes a coil 11 and a coil 12 that constitute a three-dimensional microstructure body formed in a helical structure. The metamaterial part 50 forms a double helical structure of thin wires in which the coils are wound in parallel to each other while the coil 12 faces the outer side of the coil 11. Moreover, the metamaterial part 50 includes a rod-like thin wire 51 extending in a direction in which the central axis extends at a central axis position of the helical structure on the inner side of the coil 11. The wire 51 is disposed separated from the coil 11 by a minute interval.

The coil of the metamaterial part 50 is not limited to a double coil, and may be a single coil or have a multiple coil structure of a triple or more coil. In the case of multiple coils such as a triple or more coil, the facing directions of the coils are not limited to be in the parallel positional relationship to each other, and it is favorable that the coils are arranged so as not to be in direct contact with each other.

Similarly to the coil 11 and the coil 12, the wire 51 may be a thin wire formed of a material of any one of a metal, a dielectric, a magnetic body, a semiconductor, and a superconductor, or may be a thin wire formed of a material obtained by combining two or more of those above.

Additionally, the material of the wire 51 may be the same as or different from that of the coil 11 and the coil 12. Moreover, the number of wires 51 is not limited to one, and may be two or more. Note that the wire 51 is not limited to a state of being enclosed by the coil 11 and the coil 12, and may be in a state of being adjacent to or near the coil 11 and the coil 12.

The wave control medium including the metamaterial part 50 may be disposed such that an electric field direction of the radio wave to be applied coincides with a vibration direction of electrons in which the wire 51 extends, and a magnetic field direction of the radio wave to be applied is orthogonal to a magnetic force direction electromagnetically induced by the annular current flowing in the coil 11 and the coil 12. At this time, the wire 51 responds to the magnetic field, and the coil 11 and the coil 12 respond to the electric field. In other words, the electrons vibrating along the wire 51 function with respect to the magnetic field. In addition, the coil 11 and the coil 12 function with respect to the electric field.

Functioning with respect to the magnetic field will control the relative magnetic permeability μr, and functioning with respect to the electric field will control the relative permittivity ϵr. Therefore, the wave control medium including a metamaterial part including a combination of multiple structure bodies can control the relative magnetic permeability and the relative permittivity to desired values with a high degree of freedom.

According to the wave control medium described above, in addition to the similar effects as those described in (1) to (4) above, the relative magnetic permeability and/or the relative permittivity can be finely adjusted by sharing the functions between the helical structure of the coil 11 and the coil 12 and the structure body of the wire 51. Moreover, according to the wave control medium described above, it also serves as a capacitor between the wire 51 and the coil 11, so that the capacitance can be increased as compared to the case without the wire.

### (9-2) EXAMPLE 2

Referring to FIG. 10, another example of a metamaterial part having a wire structure and a helical structure will be described. In this figure, a modified example of the metamaterial part is shown in the form of a perspective view. A metamaterial part 60 shown in the figure is the same as the metamaterial part 50 described in (9-1) above, except that a wire 61 is located outside of the coils 11 and 12 and extends in a direction orthogonal to the central axis of the coils.

In other words, the description for the metamaterial part 50 applies to the metamaterial part 60 as well.

As shown in the figure, the metamaterial part 60 includes a rod-like thin wire 61 extending in a direction orthogonal to the central axis of the helical structure of the coil 11 and the coil 12, on the outer side of the coil 11 and the coil 12. The wire 61 is disposed separated from the coil 12 by a minute interval.

The metamaterial part 60 may be disposed such that the electric field direction of the radio wave to be applied coincides with the vibration direction of electrons in which the wire 61 extends, and the magnetic field direction of the radio wave to be applied coincides with the magnetic force direction electromagnetically induced by the annular current flowing in the coil 11 and the coil 12. In this arrangement, the wire 61 responds to the electric field, and the coil 11 and the coil 12 respond to the magnetic field. In other words, the electrons vibrating along the wire 61 function with respect to the electric field.

Additionally, when the annular current is generated by vibration of electrons along the coil 11 and the coil 12, the magnetic force is induced at a central axis position at the center of the coil 11 and the coil 12 on the principle of electromagnetic induction, and as a result, the coil 11 and the coil 12 function with respect to the magnetic field.

Functioning with respect to the electric field will control the relative permittivity ϵr, and functioning with respect to the magnetic field will control the relative magnetic permeability μr. Therefore, the wave control medium including the metamaterial part 60 can control the relative permittivity and the relative magnetic permeability to desired values with a high degree of freedom.

According to the metamaterial part 60, similarly to the metamaterial part 50, in a case where desired physical properties are difficult to be obtained only by the helical structure of the coil 11 and the coil 12, the structure body of the wire 61 is combined to perform role-sharing of functions, so that the relative permittivity and/or the relative magnetic permeability can be finely adjusted.

### (9-3) EXAMPLE 3

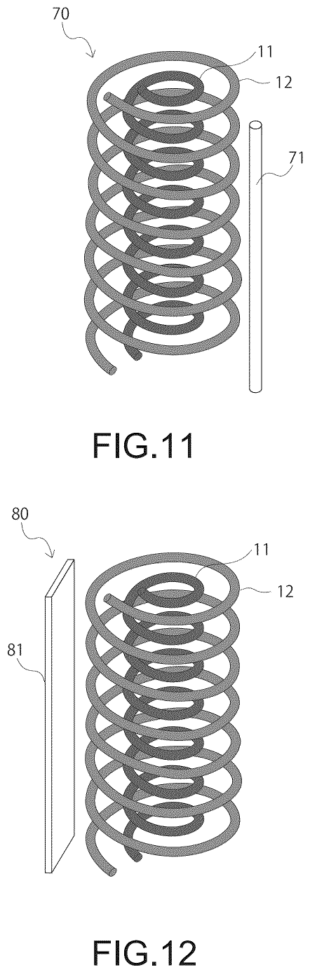

Referring to FIG. 11, another example of a metamaterial part having a wire structure and a helical structure will be described. FIG. 11 shows a configuration example of a metamaterial part 70 having those structures in the form of a perspective view. The metamaterial part 70 is the same as the metamaterial part 50 described in (9-1) above, except that a wire 71 is located outside of the coils 11 and 12 (in particular, outside of the outer side of the coils) and extends in a direction parallel to the central axis of the coils. In other words, the description for the metamaterial part 50 applies to the metamaterial part 70 as well.

As shown in the figure, the metamaterial part 70 includes a rod-like thin wire 71 extending in a direction parallel to the central axis of the helical structure of the coil 11 and the coil 12, on the outer side of the coil 11 and the coil 12. The wire 71 is disposed separated from the coil 12 by a minute interval.

The metamaterial part 70 may be disposed such that the electric field direction of the radio wave to be applied coincides with the vibration direction of electrons in which the wire 71 extends, and the magnetic field direction of the radio wave to be applied is orthogonal to the magnetic force direction electromagnetically induced by the annular current flowing in the coil 11 and the coil 12. At this time, the wire 71 responds to the magnetic field, and the coil 11 and the coil 12 respond to the electric field. In other words, the electrons vibrating along the wire 71 function with respect to the magnetic field. In addition, the coil 11 and the coil 12 function with respect to the electric field.

The wave control medium including the metamaterial part 70 can provide the similar effects as those of the wave control medium including the metamaterial part 50.

### (10) Example of Wave Control Medium Including Metamaterial Part Having Plate Structure and Helical Structure

As described in (9) above, the metamaterial part of the wave control medium of the present disclosure may have a combination of two or more types of structures. This makes it possible to, for example, cause each structure to function with respect to an electric field and a magnetic field constituting an electromagnetic wave, that is, to share functions between the structures. In (9) above, the example in which the wire structure is combined with the helical structure has been described, but other structures may be combined with the helical structure. For example, a plate structure may be combined with the helical structure.

In other words, in one embodiment, the metamaterial part may include at least two types of structure bodies, and the at least two types of structure bodies do not need to be in contact with each other. Additionally, the metamaterial part may include at least two types of structure bodies, and at least one of the at least two types of structure bodies may have a plate shape.

Examples of combinations of those structures will be described below.

### (10-1) EXAMPLE 1

Referring to FIG. 12, another example of a metamaterial part included in a wave control medium of the present disclosure will be described. FIG. 12 shows a configuration example of the metamaterial part in the form of a perspective view. A metamaterial part 80 shown in the figure may have the same configuration as the metamaterial part 10, except that a plate structure is combined with a double coil structure. In other words, the description for the metamaterial part 10 applies to the metamaterial part 80 as well.

The metamaterial part 80 also forms part of the unit structure body of the metamaterial as described in (1) to (4) above. The metamaterial part 80 is in contact with a matching element and the matching element is in contact with a base part, as described in (1) to (4) above. The wave control medium of the present disclosure may include a three-dimensional microstructure body including the metamaterial part 80, the matching element, and the base part.

As shown in the figure, the metamaterial part 80 includes a coil 11 and a coil 12 similarly to the metamaterial part 10. Moreover, the metamaterial part 80 is provided with a thin tabular plate 81 extending in a direction parallel to the central axis of the helical structure of the coil 11 and the coil 12, on the outer side of the coil 11 and the coil 12. The plate 81 is disposed separated from the coil 12 by a minute interval.

Similarly to the coil 11 and the coil 12, the plate 81 may be a plate formed of a material of any one of a metal, a dielectric, a magnetic body, a semiconductor, and a superconductor, or may be a plate formed of a material obtained by combining two or more of those above.

Additionally, the material of the plate 81 may be the same as or different from that of the coil 11 and the coil 12. Moreover, the number of plates 81 is not limited to one, and may be two or more. Note that the plate 81 can also be provided at a central axis position of the helical structure on the inner side of the coil 11 so as to be separated from the coil 11 in a direction in which the central axis extends. In this case, because it also serves as a capacitor between the plate 81 and the coil 11, the capacitance can be increased as compared to the case without the plate.

The metamaterial part 80 may be disposed such that the electric field direction of the radio wave to be applied coincides with the vibration direction of electrons in which the plate 81 extends, and the magnetic field direction of the radio wave to be applied is orthogonal to the magnetic force direction electromagnetically induced by the annular current flowing in the coil 11 and the coil 12. At this time, the plate 81 responds to the magnetic field, and the coil 11 and the coil 12 respond to the electric field. In other words, the electrons vibrating along the plate 81 function with respect to the magnetic field. In addition, the coil 11 and the coil 12 function with respect to the electric field.

Functioning with respect to the magnetic field will control the relative magnetic permeability μr, and functioning with respect to the electric field will control the relative permittivity er. Therefore, the wave control medium including the metamaterial part 80 can control the relative magnetic permeability and the relative permittivity to desired values with a high degree of freedom by combining a plurality of structure bodies.

According to the metamaterial part 80, in addition to the similar effects as those of the metamaterial part 10, the structure body of the plate 81 is combined with the helical structure of the coil 11 and the coil 12, and thus role-sharing of functions can be performed therebetween, so that the relative magnetic permeability and/or the relative permittivity can be finely adjusted.

### (10-2) EXAMPLE 2

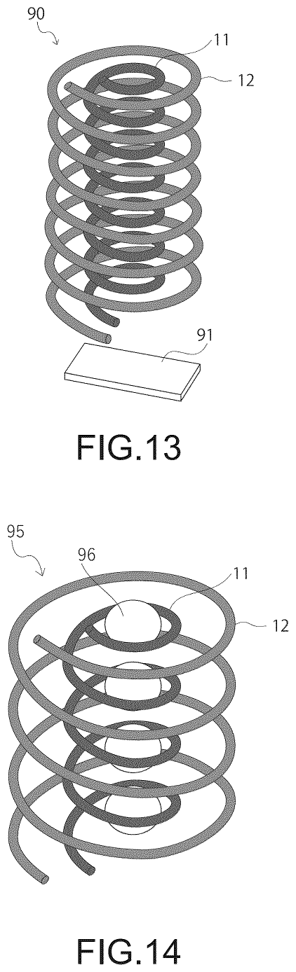

Referring to FIG. 13, another example of a metamaterial part having a plate structure and a helical structure will be described. In this figure, a configuration example of the metamaterial part is shown in the form of a perspective view. A metamaterial part 90 shown in the figure is the same as the metamaterial part 80, except that a plate is arranged such that the surface of the plate is orthogonal to the central axis of the coil. In other words, the description for the metamaterial part 80 applies to the metamaterial part 90 as well.

As shown in the figure, the metamaterial part 90 includes a plate 91. The plate 91 is disposed on the outer side of the coil 11 and the coil 12 (in particular, outside of the bottom side of the coils) and disposed such that the surface of the plate 91 is orthogonal to the central axis of the helical structure of the coil 11 and the coil 12. The plate 91 has a plate-like shape. Additionally, the plate 91 is separated from the coil 12 by a minute interval.

In the metamaterial part 90, it is assumed that the electric field direction of the radio wave to be applied coincides with the vibration direction of electrons in which the plate 91 extends, and the magnetic field direction of the radio wave to be applied coincides with the magnetic force direction electromagnetically induced by the annular current flowing in the coil 11 and the coil 12. At this time, the plate 91 functions with respect to the electric field, and the coil 11 and the coil 12 function with respect to the magnetic field. In other words, the electrons vibrating along the plate 91 function with respect to the electric field. Additionally, when the annular current is generated by vibration of electrons along the coil 11 and the coil 12, the magnetic force is induced at a central axis position at the center of the coil 11 and the coil 12 on the principle of electromagnetic induction, and as a result, the coil 11 and the coil 12 function with respect to the magnetic field.

Functioning with respect to the electric field will control the relative permittivity ϵr, and functioning with respect to the magnetic field will control the relative magnetic permeability μr. Therefore, the metamaterial part 90 can control the relative permittivity and the relative magnetic permeability to desired values with a high degree of freedom by combining a plurality of structure bodies.

Similarly to the metamaterial part 80, the metamaterial part 90 includes the structure body of the plate 81 in addition to the helical structure of the coil 11 and the coil 12, and thus role-sharing of functions can be performed therebetween, so that the relative permittivity and/or the relative magnetic permeability can be finely adjusted.

### (11) Example of Wave Control Medium Including Metamaterial Part Having Spherical Structure and Helical Structure

Referring to FIG. 14, another configuration example of a metamaterial part having a sphere structure and a helical structure will be described. In the figure, a configuration example of the metamaterial part is shown in the form of a perspective view. A metamaterial part 95 shown in the figure is configured in the same way as the metamaterial part 10, except that the sphere structure is combined with the double coil structure.

In other words, in one embodiment, the metamaterial part may include at least two types of structure bodies, and the at least two types of structure bodies do not need to be in contact with each other. Additionally, the metamaterial part may include at least two types of structure bodies, and at least one of the at least two types of structure bodies may have a spherical shape.

As shown in the figure, the metamaterial part 95 includes a coil 11 and a coil 12 that constitute a three-dimensional microstructure body similarly to the metamaterial part 10. Moreover, the metamaterial part 95 is provided with a plurality of spheres 96 aligned in a direction in which the central axis extends, at a central axis position of the helical structure of the coil 11. The spheres 96 are disposed separated from the coil 11 by a minute interval.

Similarly to the coil 11 and the coil 12, the sphere 96 may be formed of a material of any one of a metal, a dielectric, a magnetic body, a semiconductor, and a superconductor, or may be formed of a material obtained by combining two or more of those materials.

Additionally, the material of the sphere 96 may be the same as or different from that of the coil 11 and the coil 12. Moreover, the number of spheres 96 may be one, and may be two or more. Note that the spheres 96 may also be disposed on the inner side of the coil 11 or on the outer shape of the coil 12.

In the metamaterial part 95, it is assumed that the electric field direction of the radio wave to be applied coincides with the vibration direction of electrons in which the spheres 96 are aligned, and the magnetic field direction of the radio wave to be applied is orthogonal to the magnetic force direction electromagnetically induced by the annular current flowing in the coil 11 and the coil 12. At this time, the spheres 96 respond to the magnetic field, and the coil 11 and the coil 12 respond to the electric field. In other words, the electrons vibrating along the spheres 96 function with respect to the magnetic field. In addition, the coil 11 and the coil 12 function with respect to the electric field.

According to the metamaterial part 95, it is possible to obtain the similar effects as those of the metamaterial part 10. In addition, the structure body of the sphere 101 is provided in addition to the helical structure of the coil 11 and the coil 12, which makes it possible to perform role-sharing of functions therebetween and possible to finely adjust the relative magnetic permeability and/or the relative permittivity. Moreover, because the metamaterial part 95 also serves as a capacitor between the sphere 96 and the coil 11, the capacitance can be increased as compared to the case without the sphere.

### 1.3 Configuration Example of Wave Control Medium (Mushroom Structure)

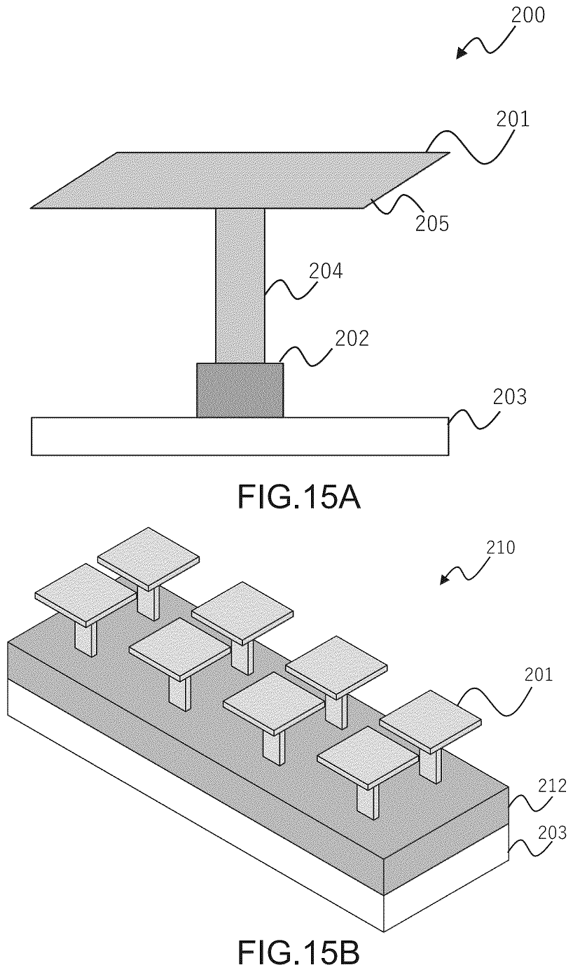

In one embodiment, a metamaterial part included in a wave control medium of the present disclosure may have a mushroom structure. Also in a wave control medium including a metamaterial part having a mushroom structure, an effect of a matching element is produced. This embodiment will be described below with reference to FIGS. 15A and 15B. FIG. 15A is a schematic view of a side surface of the wave control medium. FIG. 15B is a schematic perspective view of the wave control media disposed in an array.

A wave control medium 200 shown in FIG. 15A includes a metamaterial part 201, a matching element 202, and a base part 203. The materials of those three elements are as described in 1.1 or 1.2 above, and the description thereof also applies to this embodiment.

As shown in the figure, the metamaterial part 201 has a structure including a portion 204 corresponding to the stipe of a mushroom and a portion 205 corresponding to the pileus of the mushroom. The portion 204 corresponding to the stipe is in contact with the matching element 202. The metamaterial part 201 is in contact with the matching element 202, but need not be in contact with the base part 203.

The matching element 202 is disposed between the metamaterial part 201 and the base part 203. More specifically, the matching element 202 is in contact with the metamaterial part 201 (in particular, the above-mentioned portion 211 corresponding to the stipe) and in contact with the base part 203.

In FIG. 15A, the matching element 202 is configured to be present on a part of the surface of the base part 203, but may be present over the entire surface of the base part 203, as shown in FIG. 15B. In other words, a layer of the matching element 202 may be laminated on the surface of the base part 203.

The base part 203 is as described in 1.1 or 1.2 above, and the description thereof also applies to this embodiment.

For example, as shown in FIG. 15B, a plurality of wave control media 200 each including a mushroom-shaped metamaterial part may be disposed in an array. The plurality of wave control media 200 may be disposed in this manner to form a wave control member (or wave control element) 210. Although only eight wave control media are shown in the figure for convenience of description, it is needless to say that the number of wave control media included in the wave control member or wave control element according to the present disclosure is not limited to eight, and the wave control member or wave control element according to the present disclosure may include many wave control media.

Additionally, a matching element 212 shown in the figure is present as a film (or as a layer) on the surface of the base part 203. In other words, a plurality of mushroom-shaped metamaterial parts is disposed on one matching element 202 (in particular, on the film-like matching element 202).

The base part 203 shown in the figure is as described in 1.1 or 1.2 above, and the description thereof applies to this embodiment as well.

### 1.4 Configuration Example of Wave Control Medium (Sphere Structure or Patch Structure)

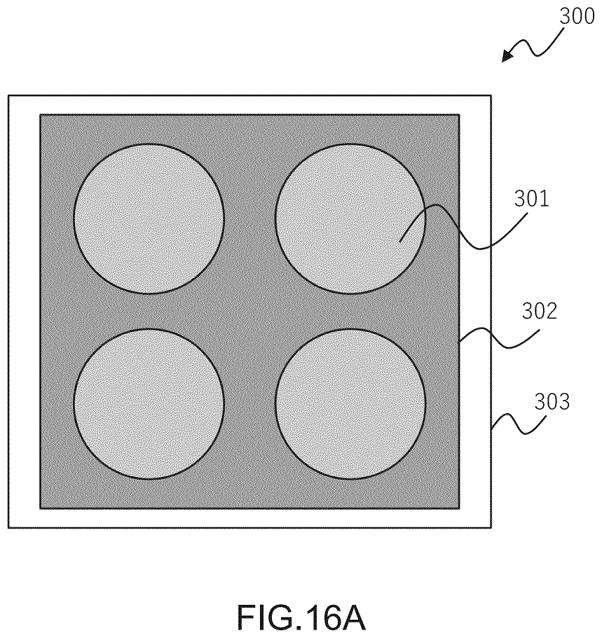

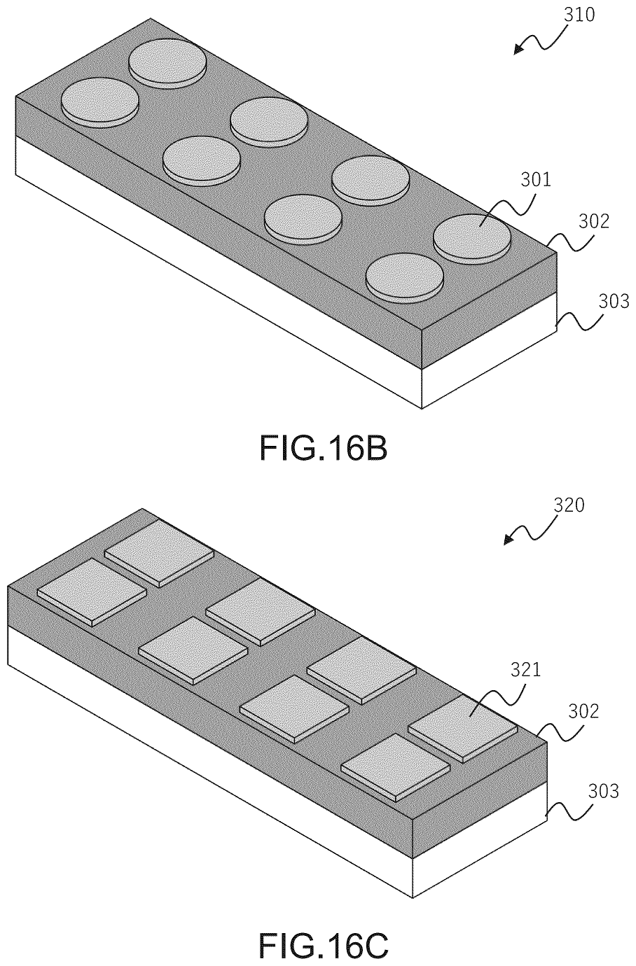

In one embodiment, a metamaterial part included in a wave control medium of the present disclosure may have a sphere structure or a patch structure. The sphere structure may be a spherical structure or a circular flat-plate structure. Also in a wave control medium including a metamaterial part of such a structure, an effect of a matching element is produced. This embodiment will be described below with reference to FIG. 16A to C. FIG. 16A is a schematic view of the top surface of a wave control medium including a sphere-shaped metamaterial part. FIG. 16B is a schematic perspective view showing a state where the wave control media are disposed in an array. FIG. 16C is a schematic perspective view showing a state where the wave control media each including a patch-shaped metamaterial part are disposed in an array.

A wave control medium 300 shown in FIG. 16A includes a metamaterial part 301, a matching element 302, and a base part 303. The materials of those three elements are as described in 1.1 or 1.2 above, and the description thereof also applies to this embodiment.

As shown in the figure, the metamaterial part 301 has a sphere structure (in particular, a circular flat-plate structure). One surface of the circular flat-plate is in contact with the matching element 302. The metamaterial part 301 is in contact with the matching element 302, but need not be in contact with the base part 303.

The matching element 302 is disposed between the metamaterial part 301 and the base part 303. More specifically, the matching element 302 is in contact with the metamaterial part 301 (in particular, one surface of the circular flat-plate) and in contact with the base part 303.

In FIG. 16A, the matching element 302 is configured to be present over substantially the entire surface of the base part 303 (i.e., the matching element 302 is laminated on the base part 303), but may be present on a part of the base part 303.

The base part 303 is as described in 1.1 or 1.2 above, and the description thereof also applies to this embodiment.

For example, as shown in FIG. 16B, a plurality of wave control medium units each including a sphere-shaped metamaterial part may be disposed in an array. As shown in the figure, the plurality of wave control media may be disposed to form a wave control member (or wave control element) 310. Although only eight wave control media are shown in the figure for convenience of description, it is needless to say that the number of wave control medium units included in the wave control member or wave control element according to the present disclosure is not limited to eight, and the wave control member or wave control element according to the present disclosure may include many wave control medium units.

Additionally, the matching element 302 shown in the figure is present as a film (or as a layer) on the surface of the base part 303. In other words, a plurality of sphere-shaped (circular flat-plate) metamaterial parts is disposed on one matching element 302 (in particular, on the film-like matching element 302).

The base part 303 shown in the figure is as described in 1.1 or 1.2 above, and the description thereof also applies to this embodiment.

In addition, as shown in FIG. 16C, for example, a plurality of wave control medium units each including a patch-shaped metamaterial part may be disposed in an array. As shown in the figure, the plurality of wave control media may be disposed to form a wave control member (or wave control element) 320. Although only eight wave control media are shown in the figure as well for convenience of description, the number of wave control medium units included in the wave control member or wave control element according to the present disclosure is not limited to this number.

Further, a matching element 322 shown in the figure is present as a film (or as a layer) on the surface of a base part 323. In other words, a plurality of patch-shaped (rectangular flat) metamaterial parts is disposed on one matching element 322 (in particular, on the film-like matching element 322).

The base part 323 shown in the figure is as described in 1.1 or 1.2 above, and the description thereof also applies to this embodiment.

### 1.5 Configuration Example of Wave Control Medium (Laminate Structure)

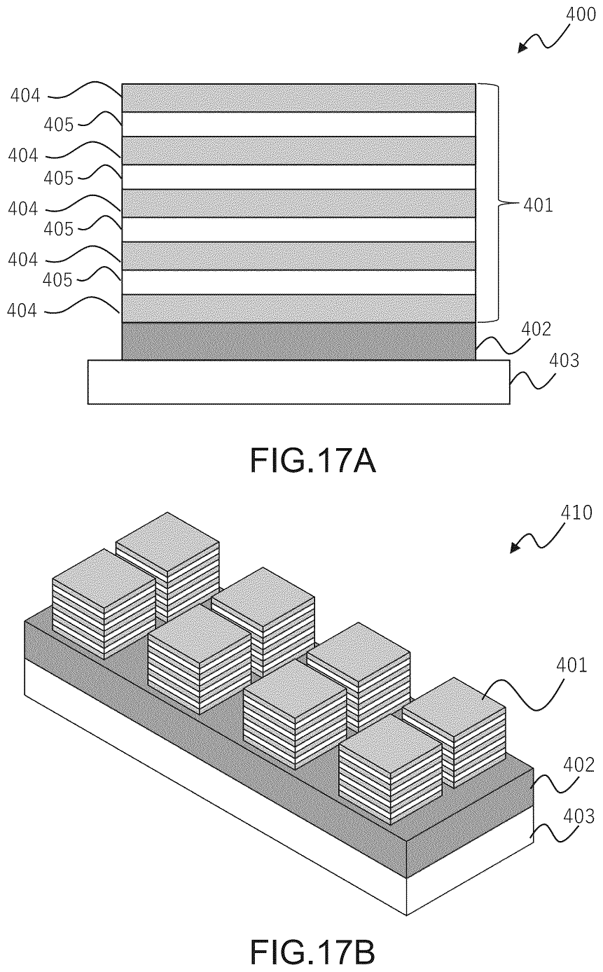

In one embodiment, a metamaterial part included in a wave control medium of the present disclosure may have a laminate structure. Also in a wave control medium including a metamaterial part of such a structure, an effect of a matching element is produced. This embodiment will be described below with reference to FIG. 17A and B. FIG. 17A is a schematic view of a side surface of a wave control medium including a laminate-type metamaterial part. FIG. 17B is a schematic perspective view showing a state where the wave control media are disposed in an array.

A wave control medium 400 shown in FIG. 17A includes a metamaterial part 401, a matching element 402, and a base part 403. The materials of those three elements are as described in 1.1 or 1.2 above, and the description thereof also applies to this embodiment.

The metamaterial part 301 has a laminate structure as shown in the figure, the laminate having a structure in which two layers 404 and 405 formed of different materials are alternately laminated. The two layers may be, for example but not limited to, a metal layer 404 and a dielectric layer 405. For example, the two layers may be any two of, for example, a metal layer, a dielectric layer, a magnetic layer, a conductor layer, a metal oxide layer, a semiconductor layer, and a superconductor layer.

In a favorable embodiment, the two layers may be a combination of “a metal layer or metal oxide layer” and “one of a dielectric layer, a magnetic layer, a conductor layer, a semiconductor layer, and a superconductor layer”, and particularly favorably a combination of “a metal layer or metal oxide layer” and “one of a dielectric layer, a magnetic layer, and a conductor layer”.

The metamaterial part 401 is in contact with the matching element 402, but need not be in contact with the base part 403. The metamaterial part 401 may be disposed on the matching element 402 such that the laminated surfaces of the laminate structure are substantially parallel to the laminated surface of the matching element 402 or the laminated surface of the base part 403, as shown in the figure.

The matching element 402 is disposed between the metamaterial part 401 and the base part 403. More specifically, the matching element 402 is in contact with an unlaminated surface in the layers of the laminate structure of the metamaterial part 401 and in contact with the base part 303.

In FIG. 17A, the matching element 402 is configured to be present over substantially the entire surface of the base part 403 (i.e., the matching element 402 is laminated on the base part 403), but may be present on a part of the base part 403.

The base part 403 is as described in 1.1 or 1.2 above, and the description thereof also applies to this embodiment.

For example, as shown in FIG. 17B, a plurality of wave control medium units each including a laminate-type metamaterial part may be disposed in an array. As shown in the figure, the plurality of wave control media may be disposed to form a wave control member (or wave control element) 410. Although only eight wave control media are shown in the figure as well for convenience of description, the number of wave control medium units included in the wave control member or wave control element according to the present disclosure is not limited to this number.

Additionally, the matching element 402 shown in the figure is present as a film (or as a layer) on the surface of the base part 403. In other words, a plurality of laminate-type metamaterial parts is disposed on one matching element 402 (in particular, on the film-like matching element 302).

The base part 403 shown in the figure is as described in 1.1 or 1.2 above, and the description thereof also applies to this embodiment.

### 1.6 Configuration Example of Wave Control Medium (Wire Structure)

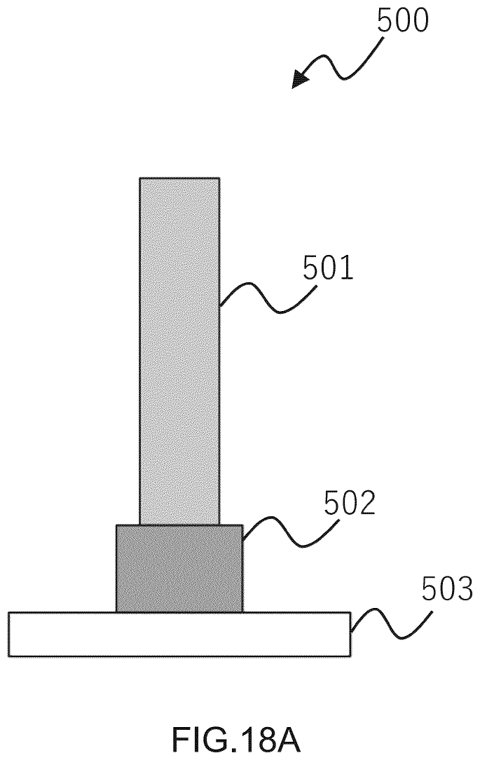

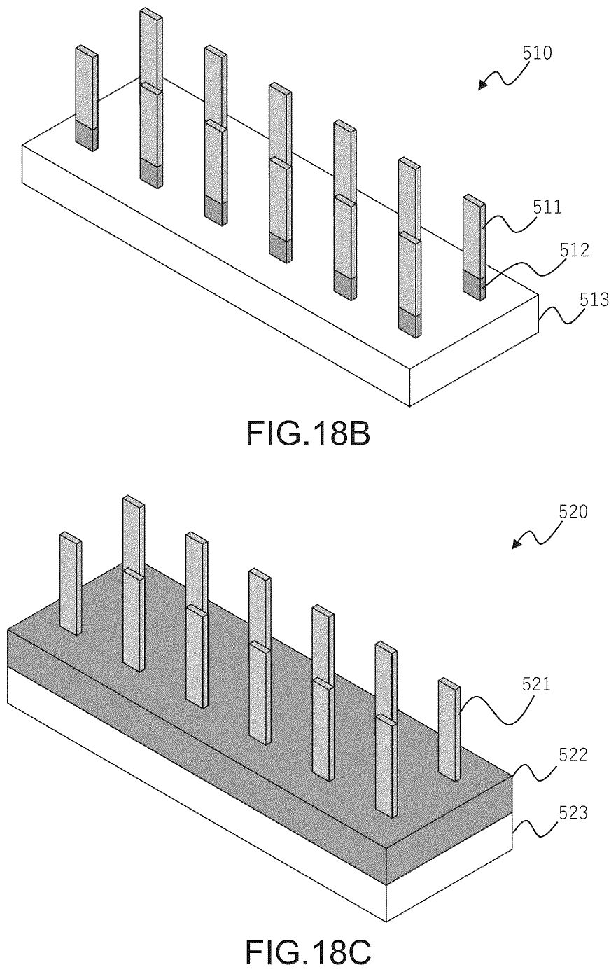

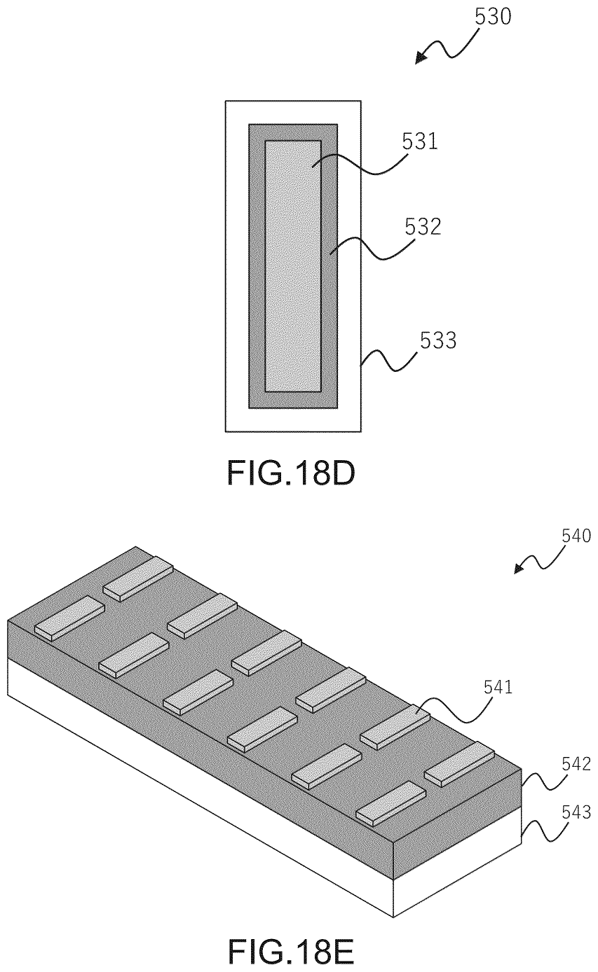

In one embodiment, a metamaterial part included in a wave control medium of the present disclosure may have a wire structure. Also in a wave control medium including a metamaterial part of such a structure, an effect of a matching element is produced. This embodiment will be described below with reference to FIG. 18A to E.

FIG. 18A is a schematic view of a side surface of a wave control medium including a wire-shaped metamaterial part. The wave control medium in the figure is configured such that one of the two ends of the wire shape in the longitudinal direction in the wire-shaped metamaterial part is in contact with a matching element. In other words, the metamaterial part is disposed such that the wire is standing on the matching element. FIG. 18B and C are schematic perspective views showing a state where the wave control media are disposed in an array.

FIG. 18C is a schematic view of the top surface of the wave control medium including the wire-shaped metamaterial part. The wave control medium in the figure is configured such that a surface or side of the wire shape in the longitudinal direction in the wire-shaped metamaterial part is in contact with a matching element. In other words, the metamaterial part is disposed such that the wire lies on the matching element. FIG. 18D is a schematic perspective view showing a state where the wave control media are disposed in an array.

A wave control medium 500 shown in FIG. 18A includes a metamaterial part 501, a matching element 502, and a base part 503. The materials of those three elements are as described in 1.1 or 1.2 above, and the description thereof also applies to this embodiment.

The metamaterial part 501 has a wire structure as shown in the figure. The metamaterial part 501 of the wire structure is in contact with the matching element 502, at one of the two ends of the metamaterial part 501 in the longitudinal direction. The metamaterial part 501 need not be in contact with the base part 503. As shown in the figure, the metamaterial part 501 may be disposed to stand on the matching element 502, and in particular, may be disposed to stand perpendicular to the surface of the base part 503.

The matching element 502 is disposed between the metamaterial part 501 and the base part 503. More specifically, the matching element 502 is in contact with an unlaminated surface in the layers of the laminate structure of the metamaterial part 401 and in contact with the base part 303.

For example, as shown in FIG. 18B, a plurality of wave control medium units each including a wire-shaped metamaterial part 511 may be disposed in an array. As shown in the figure, the plurality of wave control media may be disposed to form a wave control member (or wave control element) 510. Although only eight wave control media are shown in the figure as well for convenience of description, the number of wave control medium units included in the wave control member or wave control element according to the present disclosure is not limited to this number.

Additionally, matching elements 512 shown in the figure are disposed only in the portions, on the surface of a base part 513, where the metamaterial parts are located. The plurality of matching elements 512 is disposed on the base part 513, spaced apart from each other, and one wire-shaped metamaterial part is disposed on each of the matching elements.

The base part 513 shown in the figure is as described in 1.1 or 1.2 above, and the description thereof also applies to this embodiment.

In FIG. 18B, the plurality of matching elements is disposed on the base part, and the metamaterial parts are disposed on the respective matching elements. In the present disclosure, a plurality of metamaterial parts may be disposed on a single matching element as described above. This will be described with reference to FIG. 18C.

FIG. 18C shows a wave control member (or wave control element) 520 in which a plurality of wave control medium units each including a wire-shaped metamaterial part 521 is disposed in an array. Although only eight wave control media are shown in this figure as well for convenience of description, the number of wave control medium units included in the wave control member or wave control element according to the present disclosure is not limited to this number.

A matching element 522 shown in the figure is present over the entire surface of a base part 523, and the matching element 522 is configured to be present over substantially the entire surface of the base part 523.

The base part 523 shown in the figure is as described in 1.1 or 1.2 above, and the description thereof also applies to this embodiment.

A wave control medium 530 shown in FIG. 18D includes a metamaterial part 531, a matching element 532, and a base part 533. The materials of those three elements are as described in 1.1 or 1.2 above, and the description thereof also applies to this embodiment.

The metamaterial part 531 has a wire structure as shown in the figure. In the metamaterial part 531 of the wire structure, one of the surfaces present in the longitudinal direction is in contact with the matching element 532. The metamaterial part 531 does not have to be in contact with the base part 533. The metamaterial part 531 may be disposed to lie on the matching element 532, as shown in the figure.

The matching element 532 is disposed between the metamaterial part 531 and the base part 533. More specifically, the matching element 502 is in contact with an unlaminated surface in the layers of the laminate structure of the metamaterial part 401 and in contact with the base part 303.

For example, as shown in FIG. 18E, a plurality of wave control medium units each including a wire-shaped metamaterial part 541 may be disposed in an array. As shown in the figure, the plurality of wave control media may be disposed to form a wave control member (or wave control element) 510. Although only eight wave control media are shown in the figure as well for convenience of description, the number of wave control medium units included in the wave control member or wave control element according to the present disclosure is not limited to this number.

Additionally, a matching element 542 shown in the figure is present over the entire surface of a base part 543, but may be disposed only in a portion where the metamaterial part is present as described above.

The base part 543 shown in the figure is as described in 1.1 or 1.2 above, and the description thereof also applies to this embodiment.

### 1.7 Configuration Example of Wave Control Medium (Ring Structure)

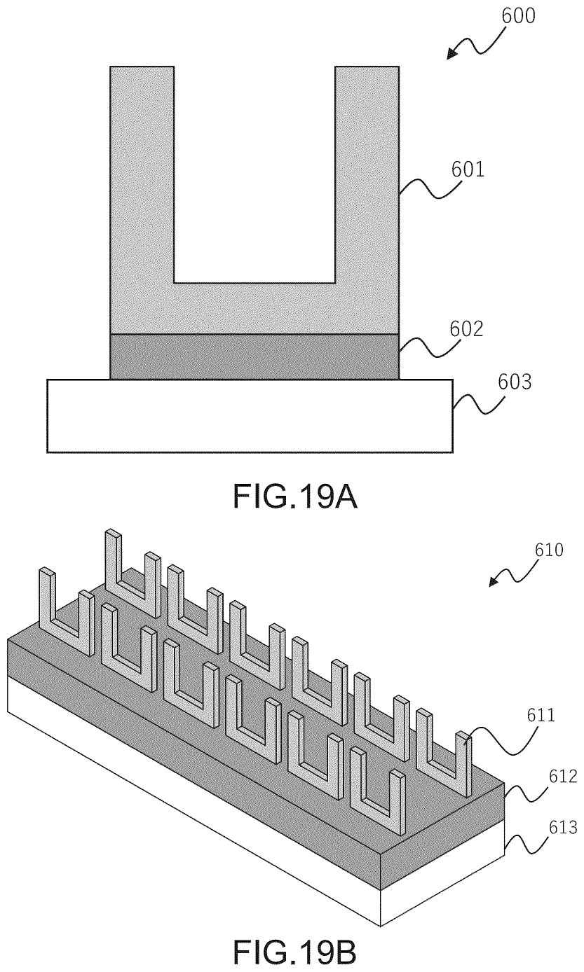

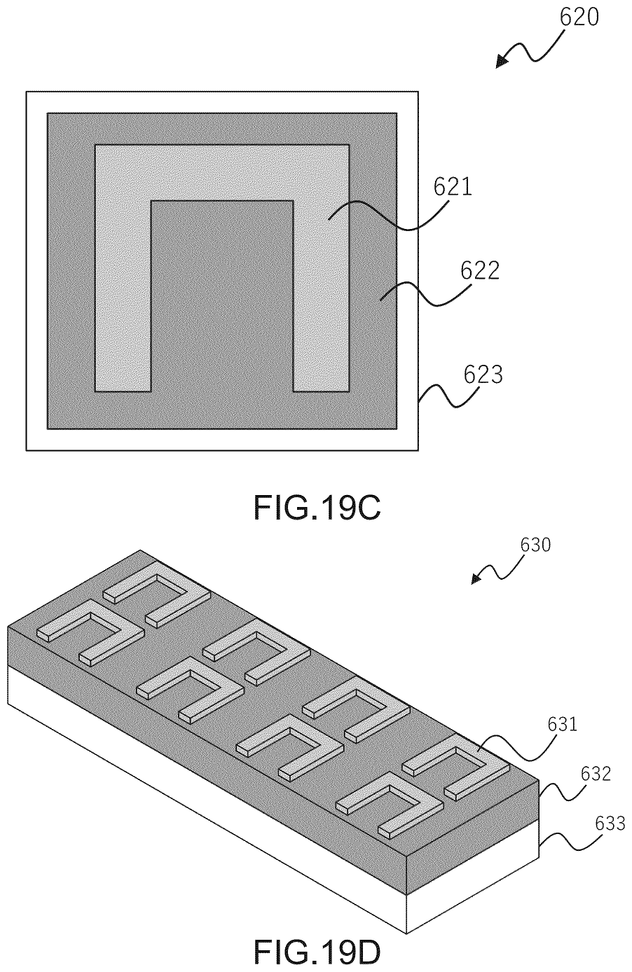

In one embodiment, a metamaterial part included in a wave control medium of the present disclosure may have a ring structure. Also in a wave control medium including a metamaterial part of such a structure, an effect of a matching element is produced. This embodiment will be described below with reference to FIG. 19A to D.

FIG. 19A is a schematic view of a side surface of a wave control medium including a ring-shaped metamaterial part. A wave control medium 600 shown in the figure includes a metamaterial part 601, a matching element 602, and a base part 603. The materials of those three elements are as described in 1.1 or 1.2 above, and the description thereof also applies to this embodiment.

The ring shape of the metamaterial part 601 may be like a U-shape, with one portion of the ring missing. The wave control medium 600 in the figure is configured such that the lower portion of the U-shape in the ring-shaped metamaterial part 601 is in contact with the matching element 602 and the missing portion is at the farthest position from the matching element 602. In other words, the metamaterial part is disposed such that the U-shape stands on the matching element.

The matching element 602 is disposed between the metamaterial part 601 and the base part 603. More specifically, the matching element 602 is in contact with the lower portion of the metamaterial part 601 and with the base part 603.

The base part 603 is as described in 1.1 or 1.2 above, and the description thereof also applies to this embodiment.

FIG. 19B is a schematic perspective view showing a state where the wave control media are disposed in an array. As shown in the figure, a plurality of wave control medium units each including a ring-shaped metamaterial part 611 may be disposed in an array. As shown in the figure, the plurality of wave control media may be disposed to form a wave control member (or wave control element) 610. Although only eight wave control media are shown in the figure as well for convenience of illustration, the number of wave control medium units included in the wave control member or wave control element according to the present disclosure is not limited to this number.

Additionally, a matching element 612 shown in the figure is laminated over the entire surface of a base part 613, and is, for example, a film laminated on the base part 613.

The base part 613 shown in the figure is as described in 1.1 or 1.2 above, and the description thereof also applies to this embodiment.

FIG. 19C is a schematic view of the top surface of a wave control medium including a ring-shaped metamaterial part. A wave control medium 620 shown in the figure includes a metamaterial part 621, a matching element 622, and a base part 623. The materials of those three elements are as described in 1.1 or 1.2 above, and the description thereof also applies to this embodiment. The wave control medium 620 in the figure is configured such that the ring-like U-shape is described on the matching element. In other words, the metamaterial part 621 is disposed such that the ring-like U-shape lies on the matching element 622.

FIG. 19D shows a wave control member (or wave control element) 630 in which a plurality of wave control medium units each including a ring-shaped metamaterial part 631 is disposed in an array. Although only eight wave control media are shown in this figure as well for convenience of description, the number of wave control medium units included in the wave control member or wave control element according to the present disclosure is not limited to this number.

A matching element 632 shown in the figure is present over the entire surface of a base part 633, and the matching element 632 is configured to be present over substantially the entire surface of the base part 633.

The base part 633 shown in the figure is as described in 1.1 or 1.2 above, and the description thereof also applies to this embodiment.

### 2 Second Embodiment (Electromagnetic Wave Absorbing Member)

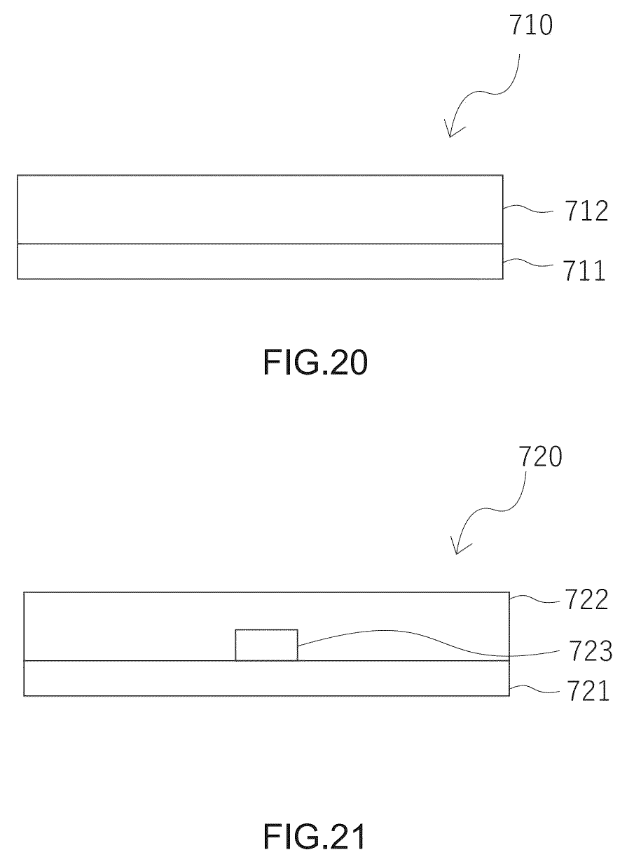

An electromagnetic wave absorbing member according to the present disclosure will be described with reference to FIG. 20. FIG. 20 shows a configuration example of an electromagnetic wave absorbing member 710 according to the present disclosure. FIG. 20 is a schematic cross-sectional view of a surface perpendicular to the extending direction of the electromagnetic wave absorbing member 110. The cross-section of the electromagnetic wave absorbing member 710 may have a rectangular shape as shown in the figure, but may have other shapes.

The electromagnetic wave absorbing member 710 includes a support 711 and a wave control member 712 located on the support 711. The electromagnetic wave absorbing member 710 may have a sheet shape in which the support 711 and the wave control member 712 are superimposed on each other, but may have other shapes depending on the shapes of the support 711 and the wave control member 712.

The support 711 may be formed of a metal, a dielectric, or a resin. The support 711 may be in the form of a layer, a sheet, or a film, for example.

The wave control member 712 may be a wave control member in which any wave control media described in 1 above are disposed in an array, or a wave control member in which any wave control media described in 1 above are dispersively disposed. The wave control member 712 may be in the form of a layer, a sheet, or a film.

The refractive index of the wave control member 712 may be controlled such that the wave control member 712 absorbs electromagnetic waves. With the wave control member 712 having such a controlled refractive index, the electromagnetic wave absorbing member 710 may be used as a member that absorbs applied electromagnetic waves.

Additionally, in the electromagnetic wave absorbing member 710, the refractive index of the wave control medium 712 may be controlled such that the wave control medium 712 blocks electromagnetic waves. With the wave control member 712 having such a controlled refractive index, the electromagnetic wave absorbing member 710 may be used as a member that blocks applied electromagnetic waves.

Further, the electromagnetic wave absorbing member 710 may be used in a communication device that uses electromagnetic waves for communication, in a detection device that uses electromagnetic waves for detection, and the like. Examples the communication device include a communication device for ETC and an IC card (IC chip) reader. In addition, the electromagnetic wave absorbing member 710 can be applied, as the detection device, to a sensor that uses electromagnetic waves, such as a radar system (in particular, components of radar system, such as antenna, transmitter, and receiver).

The electromagnetic wave absorbing member 710 may be included as an element of such a device.

### 3 Third Embodiment (Electromagnetic Waveguide)

### (1) Configuration Example 1 of Electromagnetic Waveguide

A configuration example of an electromagnetic waveguide 720 according to the present disclosure will be described with reference to FIG. 21. FIG. 21 is a schematic cross-sectional view of a surface perpendicular to the extending direction of the electromagnetic waveguide. The cross-section of the electromagnetic waveguide 720 may have a rectangular shape as shown in the figure, but may have other shapes such as a circle or an oval.

The electromagnetic waveguide 720 includes a support 721, and a waveguide 723 and a medium 722 located on the support 721. The electromagnetic waveguide 720 is configured such that the waveguide 723 is surrounded by the support 721 and the medium 722.

The support 721 may be formed of, for example, silicon (Si), a metal, a dielectric, or a resin.

The medium 722 may be formed of, for example, silicon dioxide (SiO₂) or a dielectric.

The waveguide 723 may be a wave control member in which any wave control media described in 1 above are disposed in an array, or a wave control member in which any wave control media described in 1 above are dispersively disposed. The waveguide 723 may have a wire shape. The cross-sectional shape of the waveguide 723 need not be the square shown in the figure, but may be a circle or an oval, for example.

The electromagnetic waveguide 720 is configured such that electromagnetic waves travel within the waveguide 123. To this end, for example, the refractive index of the waveguide 123 may be controlled, and the materials of the support 721 and the medium 722 may be selected as appropriate by a person skilled in the art. The electromagnetic waveguide 720 may be provided, for example, in an information processing device, in particular, in an arithmetic element or a storage element.

### (2) Configuration Example 2 of Electromagnetic Waveguide

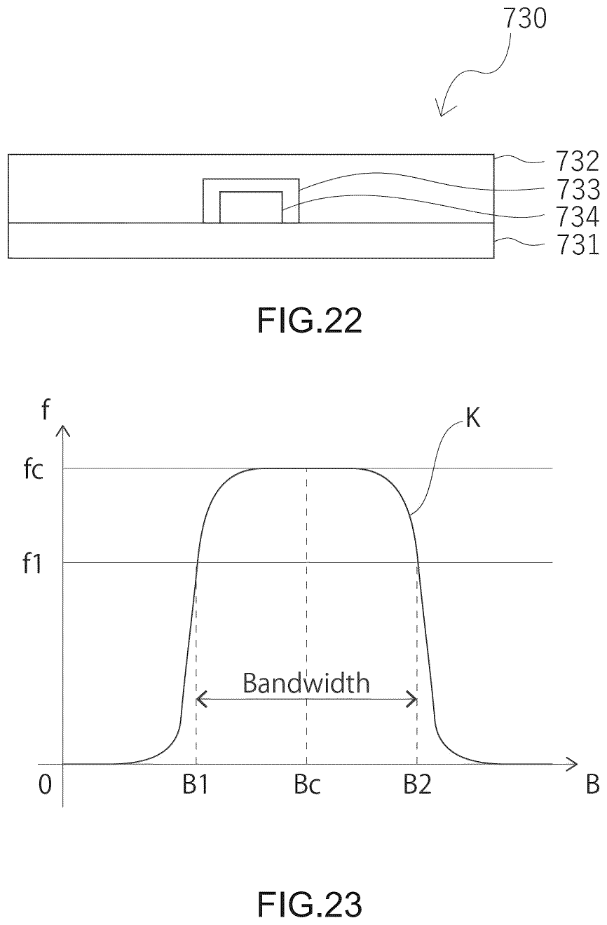

An electromagnetic waveguide 730 according to the present disclosure will be described with reference to FIG. 22. FIG. 22 is a schematic cross-sectional view of a surface perpendicular to the extending direction of the electromagnetic waveguide. The cross-section of the electromagnetic waveguide 730 may have a rectangular shape as shown in the figure, but may have other shapes such as a circle or an oval.

The electromagnetic waveguide 730 includes a support 731, a waveguide 733 and a medium layer 734 located on the support 731, and a medium 732. As shown in the figure, the waveguide 733 is surrounded by the medium layer 734 and the support 731. The medium 732 is configured to surround the medium layer 734.

The support 731 and the medium 732 may be the same as the support 721 and the medium 722, and the description thereof also applies to the support 731 and the medium 732.

The waveguide 733 may be a wave control member in which any wave control media described in 1 above are disposed in an array, or a wave control member in which any wave control media described in 1 above are dispersively disposed. The waveguide 733 may have a wire shape. The cross-sectional shape of the waveguide 733 need not be the square shown in the figure, but may be a circle or an oval, for example.

The medium layer 734 may be disposed so as to surround the circumference of the waveguide 733 and may be laminated on the circumference of the waveguide 733 in the form of a layer. The medium layer 734 may be formed of silicon (Si) or a resin.

The electromagnetic waveguide 720 is configured such that electromagnetic waves travel within the waveguide 123. To this end, for example, the refractive index of the waveguide 123 may be controlled, and the materials of the support 721 and the medium 722 may be selected as appropriate by a person skilled in the art. The electromagnetic waveguide 720 may be provided, for example, in an information processing device, in particular, in an arithmetic element or a storage element.

### 4 Specific Bandwidth

A specific bandwidth of a metamaterial including a wave control medium according to the present disclosure will be described with reference to FIG. 23. FIG. 23 is a graph for describing an example of the specific bandwidth of the metamaterial including the wave control medium according to the present disclosure that includes a metamaterial part having a helical structure.

In the same figure, the vertical axis of the graph represents a frequency f, and the horizontal axis represents a frequency band B. A curve K in the figure shows a relationship between the bandwidth B and the frequency f of the metamaterial including the wave control medium described above.

The specific bandwidth of the metamaterial is obtained from the curve K. Here, the bandwidth refers to an inter-band distance of a frequency of 2½ of the peak frequency, and the specific bandwidth refers to a value obtained by dividing the bandwidth by the peak frequency that is the center frequency.

In the curve K, the frequency is a peak frequency fc in a band Bc, and is a frequency f1 which is 2½ of the peak frequency in the bands B1 and B2.Therefore, in the curve K, the bandwidth is B2−B1, and the specific bandwidth is (B2−B1) /fc.

Favorably, the specific bandwidth of a response of the metamaterial is 30% or more, and the absorption intensity in the specific bandwidth is 50% or more. In other words, the present disclosure provides a wave control element or wave control member including the wave control medium described above and having a specific bandwidth of a response of 30% or more, and an absorption intensity in the specific bandwidth of 50% or more. Note that, in the wave control element, the above wave control medium may be integrated in an array structure, or a plurality of the wave control media may be dispersedly disposed.

### 5 Use Examples

The metamaterial (especially, wave control element or wave control member) according to the present disclosure may be used, for example, in various devices, such as a wave control device (e.g., a wave control device that performs transmission/reception or light reception/emission, and antennas such as a small antenna and a low-profile antenna). In other words, the present disclosure provides those devices including the metamaterials.

Additionally, the metamaterial according to the present disclosure may also be configured as, for example, a frequency selection filter, an artificial magnetic conductor, an electro band gap member, a noise suppression member, an isolator, a radio wave lens, a radar member, an optical lens, an optical film, an optical element for terahertz, an optical camouflage member, an invisibility member, a heat dissipation member, a heat shielding member, or a heat storage member.

In addition, the metamaterial according to the present disclosure may also be used in devices such as devices that perform electromagnetic wave modulation/demodulation, wavelength conversion, or the like, non-linear devices, and speakers. In other words, the present disclosure also provides those devices including the metamaterials.

### 6 EXAMPLES

### 6.1 Example 1

The electromagnetic wave absorption characteristics in a predetermined wavelength range were simulated for a wave control medium including a base part and a metamaterial part (also referred to as “wave control medium in Reference example”) and for a wave control medium including a base part, a matching element, and a metamaterial part (also referred to as “wave control medium in Example”).

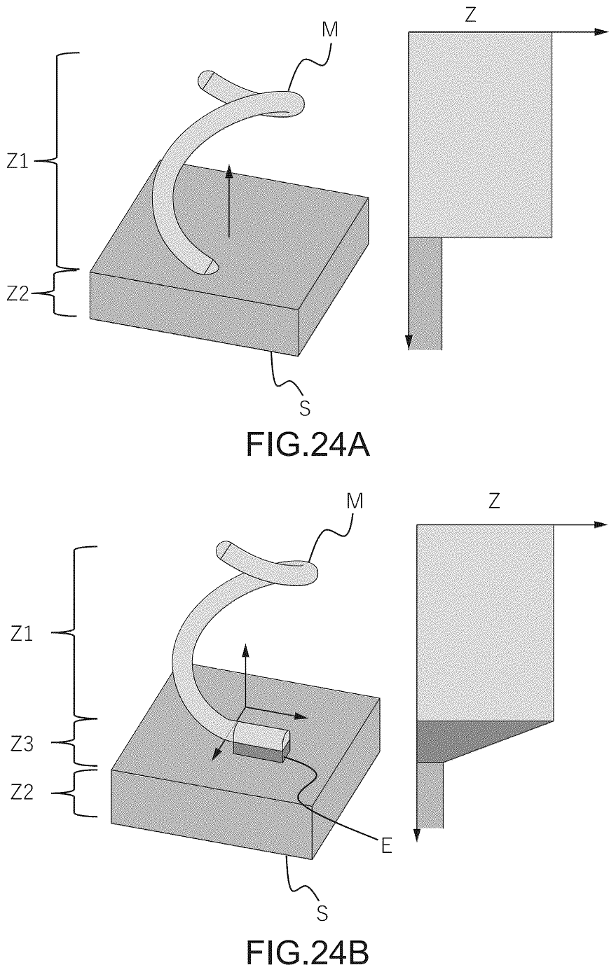

The structure of the wave control medium in Reference example used in the simulation is shown in FIG. 24A. Additionally, the wave control medium in Example used in the simulation is shown in FIG. 24B.

The wave control medium shown in the left diagram of FIG. 24A includes a metamaterial part M having a helical structure and a base part S on which the metamaterial part is disposed. The impedance of the metamaterial part is Z1 and the impedance of the base part is Z2.

The right diagram of the same figure schematically shows the impedances of those components, where the horizontal axis is the impedance value and the vertical axis corresponds to a position on the axis indicated by the arrow in the left diagram, from top to bottom. Note that in the right diagram the direction of the arrow is opposite to that in the left diagram in order to correspond to the traveling direction of the incident wave.

As shown in the right diagram, the difference between the impedances Z1 and Z3 is large, that is, the impedance value varies significantly between the metamaterial part M and the base part S.

The wave control medium shown in the left diagram of FIG. 24B includes a metamaterial part M having a helical structure, a base part S on which the metamaterial part is disposed, and a matching element E disposed between the metamaterial part and the base part. The impedance of the metamaterial part is Z1 and the impedance of the base part is Z2. Additionally, the impedance of the matching element E is Z3.

The right diagram of the same figure schematically shows the impedances of those components, where the horizontal axis is the impedance value and the vertical axis corresponds to a position on the axis indicated by the arrow in the left diagram, from top to bottom. Note that in the right diagram the direction of the arrow is opposite to that in the left diagram in order to correspond to the traveling direction of the incident wave. As shown in the right diagram, the difference between the impedances Z1 and Z3 is large, but the change in impedance value is considered to be gradual due to the matching element E disposed between the metamaterial part M and the base part S.

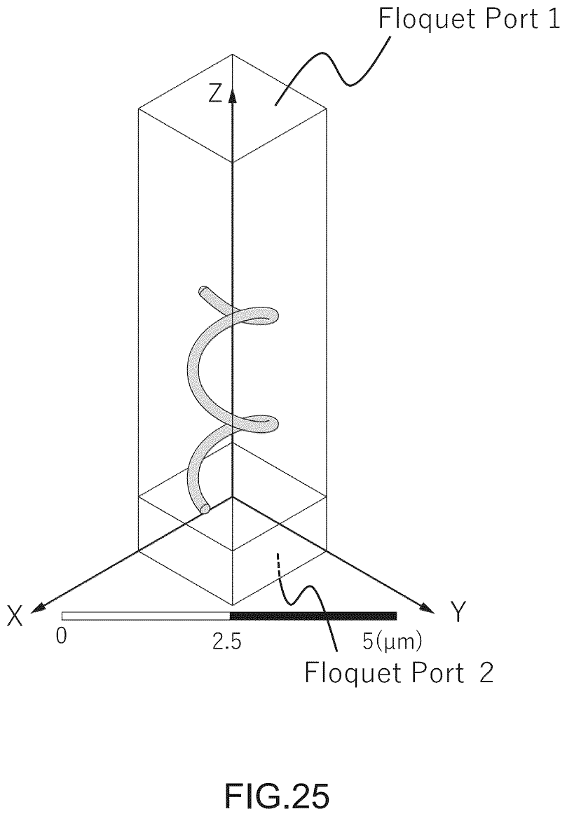

The simulation methods described above were as follows. A finite element electromagnetic field analysis was used for the electromagnetic wave absorption characteristics described above. As shown in FIG. 25, Floquet Port 1 and Floquet Port 2 were disposed on the top and bottom surfaces of a computational domain, respectively, and plane waves were incident in a perpendicular direction toward the substrate (corresponding to a base part). Further, periodic boundary conditions were also established on the side surfaces of the computational domain.

An absorbance Abs for plane waves at each wavelength was calculated using the absolute values of S11 and S21 (mag(S11) and mag(S21) ) in the S parameters between the Floquet Ports described above, using the following formulae.

Abs=1−trans−reflec

Trans=mag(S11)^2

Reflec=mag(S21)^2

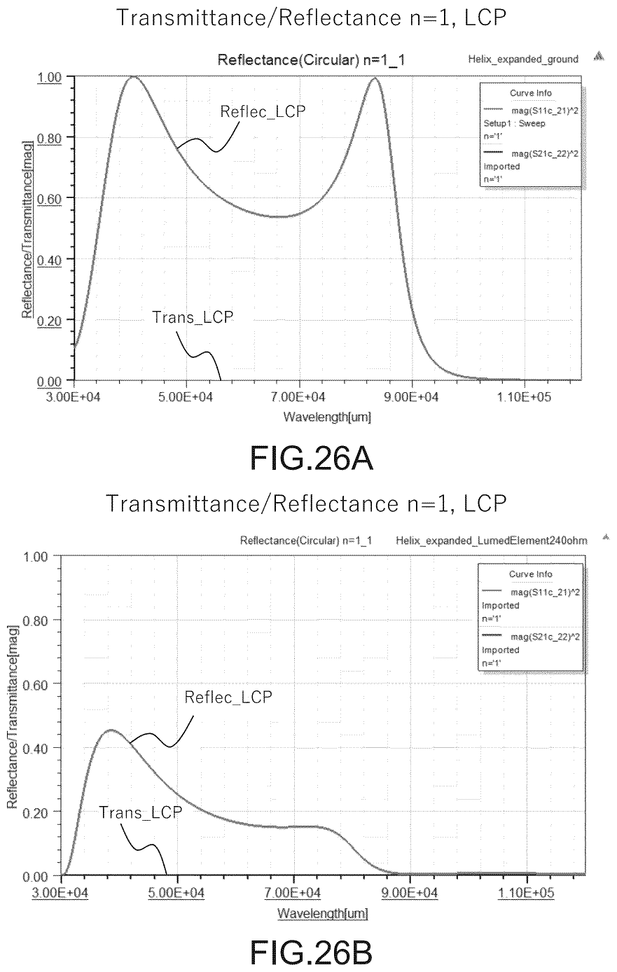

The resulting absorbance was plotted with respect to the wavelength. The plot results are shown in FIGS. 26A and 26B. FIG. 26A shows the simulation results for the wave control medium in Reference example, and FIG. 26B shows the simulation results for the wave control medium in Example.

As shown in those results, the reflection intensity (Reflec_LCP) of a left circularly polarized wave (also referred to as left-handed circular polarization, LCP, or Left Circular Polarization) is much lower in the wave control medium in Example than in Reference example. Therefore, the matching element disposed between the base part and the metamaterial part can suppress the reflection of electromagnetic waves, i.e., enhance the absorption characteristics.

Note that in those results the transmission intensity of the left circularly polarized wave (Trans_LCP) was zero over the simulated wavelength range for both the wave control medium in Reference example and the wave control medium in Example.

### 6.2 Example 2

### (Wire Structure)

The same simulations as those described in Example 1 above were performed for the wave control medium shown in FIG. 18E. As a result, the reflection intensity of a linearly polarized wave was 21% at an incident wavelength of 82 mm. On the other hand, in Reference example without including a matching element (resistive film), the reflection intensity was 92%.

### (Ring Structure)

The same simulations as those described in Example 1 above were performed for the wave control medium shown in FIG. 19D. As a result, the reflection intensity of a linearly polarized wave was 18% at an incident wavelength of 82 mm. On the other hand, in Reference example without including a matching element (resistive film), the reflection intensity was 79%.

Those results show that even when metamaterials having various structures other than the helical structure are employed, reflection can be suppressed by the matching element.

Note that the present disclosure may be configured as follows.

[1]

A wave control medium, including
a three-dimensional microstructure body including a base part, a metamaterial part, and a matching element disposed between the base part and the metamaterial part, in which
the three-dimensional microstructure body is formed of a material selected from any one of a metal, a dielectric, a magnetic body, a conductor, a metal oxide, a semiconductor, and a superconductor, or a combination of a plurality of those above.
   [2]

The wave control medium according to [1], in which
the metamaterial part has a helical structure, a multilayer structure, a conical structure, a wire structure, a ring structure, a mushroom structure, or a sphere structure.
   [3]

The wave control medium according to [1] or [2], in which
the matching element is formed of a resistive material.
   [4]

The wave control medium according to [1] or [2], in which
the matching element is a film or a wire that is formed of a resistive material.
   [5]

The wave control medium according to [1] or [2], in which
the matching element is a lumped element.
   [6]

The wave control medium according to any one of to [5], in which
the metamaterial part includes at least two types of structure bodies, and
the at least two types of structure bodies are not in contact with each other.
   [7]

The wave control medium according to any one of to [5], in which
the metamaterial part includes at least two types of structure bodies, and
the at least two types of structure bodies are not in contact with each other and have a continuous structure formed in a manner that the at least two types of structure bodies are entangled with each other.
   [8]

The wave control medium according to any one of to [5], in which
the metamaterial part includes at least two types of structure bodies, and
at least one of the at least two types of structure bodies has a wire shape, a plate shape, or a sphere shape.
   [9]

A wave control member, including
the wave control medium according to any one of to [8].
   [10]

The wave control member according to [9], in which
a specific bandwidth of a response of the wave control member is 30% or more, and
an absorption intensity in the specific bandwidth is 50% or more.
   [11]

A wave control member for electromagnetic wave absorption or electromagnetic wave shielding, including
the wave control medium according to any one of to [8].
   [12]

The wave control member according to any one of to [11], in which
a plurality of metamaterial parts is disposed on one matching element.
   [13]

The wave control member according to [12], in which
the one matching element is a film formed on the base part.
   [14]

The wave control member according to any one of to [11], in which
a plurality of combinations of the matching element and the metamaterial part is disposed on one base part.
   [15]

The wave control member according to [14], in which
a plurality of matching elements constituting the plurality of combinations is configured not to be in contact with each other.
   [16]

A wave control element, including
the wave control medium according to any one of [1] to [8].
   [17]

The wave control element according to [16], in which
a specific bandwidth of a response of the wave control element is 30% or more, and
an absorption intensity in the specific bandwidth is 50% or more.
   [18]

A wave control device, including
a metamaterial including the wave control medium according to any one of [1] to [8].
   [19]

A wave control device, including
a sensor including the wave control member according to any one of [9] to [12].
   [20]

A wave control device that performs transmission/reception or light reception/emission, including
the wave control medium according to any one of [1] to [8].

Hereinabove, the embodiments and examples of the present disclosure have been specifically described, but the present disclosure is not limited to the embodiments and examples described above, and various modifications based on the technical concept of the present disclosure are made possible.

For example, the configurations, methods, processes, shapes, materials, numerical values, and the like listed in the embodiments and examples described above are only examples, and different configurations, methods, processes, shapes, materials, numerical values, and the like may be used as necessary. Additionally, the configurations, methods, processes, shapes, materials, numerical values, and the like in the embodiments and examples described above can be combined with each other as long as they do not deviate from the main purpose of the present disclosure.

In addition, in this specification, the numerical range indicated using “to” indicates a range that includes the numerical values listed before and after “to” as the minimum and maximum values, respectively. In numerical ranges described herein in steps, the upper or lower limit of the numerical range at a certain step may be replaced with the upper or lower limit of the numerical range at another step.

### REFERENCE SIGNS LIST

1 wave control medium
2 base part
3 metamaterial part
4 matching element

1. A wave control medium, comprising
a three-dimensional microstructure body including a base part, a metamaterial part, and a matching element disposed between the base part and the metamaterial part, wherein
the three-dimensional microstructure body is formed of a material selected from any one of a metal, a dielectric, a magnetic body, a conductor, a metal oxide, a semiconductor, and a superconductor, or a combination of a plurality of those above.

2. The wave control medium according to claim 1, wherein
the metamaterial part has a helical structure, a multilayer structure, a conical structure, a wire structure, a ring structure, a mushroom structure, or a sphere structure.

3. The wave control medium according to claim 1, wherein
the matching element is formed of a resistive material.

4. The wave control medium according to claim 1, wherein
the matching element is a film or a wire that is formed of a resistive material.

5. The wave control medium according to claim 1, wherein
the matching element is a lumped element.

6. The wave control medium according to claim 1, wherein
the metamaterial part includes at least two types of structure bodies, and
the at least two types of structure bodies are not in contact with each other.

7. The wave control medium according to claim 1, wherein
the metamaterial part includes at least two types of structure bodies, and
the at least two types of structure bodies are not in contact with each other and have a continuous structure formed in a manner that the at least two types of structure bodies are entangled with each other.

8. The wave control medium according to claim 1, wherein
the metamaterial part includes at least two types of structure bodies, and
at least one of the at least two types of structure bodies has a wire shape, a plate shape, or a sphere shape.

9. A wave control member, comprising
the wave control medium according to claim 1.

10. The wave control member according to claim 9, wherein
a specific bandwidth of a response of the wave control member is 30% or more, and
an absorption intensity in the specific bandwidth is 50% or more.

11. A wave control member for electromagnetic wave absorption or electromagnetic wave shielding, comprising
the wave control medium according to claim 1.

12. The wave control member according to claim 9, wherein
a plurality of metamaterial parts is disposed on one matching element.

13. The wave control member according to claim 12, wherein
the one matching element is a film formed on the base part.

14. The wave control member according to claim 9, wherein
a plurality of combinations of the matching element and the metamaterial part is disposed on one base part.

15. The wave control member according to claim 14, wherein
a plurality of matching elements constituting the plurality of combinations is configured not to be in contact with each other.

16. A wave control element, comprising
the wave control medium according to claim 1.

17. The wave control element according to claim 16, wherein
a specific bandwidth of a response of the wave control element is 30% or more, and
an absorption intensity in the specific bandwidth is 50% or more.

18. A wave control device, comprising
a metamaterial including the wave control medium according to claim 1.

19. A wave control device, comprising
a sensor including the wave control member according to claim 9.

20. A wave control device that performs transmission/reception or light reception/emission, comprising
the wave control medium according to claim 1.
